(19) United States
(12) Patent Application Publication
(10) Pub. No.: US 2025/0173160 A1
(43) Pub. Date: May 29, 2025

(54) SYSTEM OPERATION PLANNING DEVICE, DISPLAY DEVICE, SYSTEM OPERATION PLANNING METHOD, AND RECORDING MEDIUM

(71) Applicant: NEC Corporation, Minato-ku, Tokyo (JP)

(72) Inventor: Takayuki KURODA, Tokyo (JP)

(73) Assignee: NEC Corporation, Minato-ku, Tokyo (JP)

(21) Appl. No.: 18/859,609

(22) PCT Filed: May 30, 2022
(86) PCT No.: PCT/JP2022/021890

§ 371 Date: Oct. 24, 2024

(51) Int. Cl. G06F 9/445

(52) U.S. Cl. CPC G06F 9/44505

(57) ABSTRACT

A system operation planning device generates, based on abstract requirements that are information indicating requirements to be satisfied by a target system as a system to be operated, specific requirements that are information indicating requirements to be satisfied by the target system, the specific requirements including information indicating values of each of a plurality of values of a variable factor included in a variable factor range, the information including information indicating a variable factor range as a range of values allowed for a variable factor to take during operation of the target system, the value of the variable factor being a value varying during the operation of the target system and having a correlation with an operation status of the target system.

### TECHNICAL FIELD

The present invention relates to a system operation planning device, a display device, a system operation planning method, and a recording medium.

### BACKGROUND ART

Techniques related to the design or operation of systems such as ICT (Information and Communication Technology) systems have been proposed.

For example, Non Patent Document 1 describes a technique for automatic system design. Furthermore, patent documents 1 to 3 disclose techniques related to procedures for transitioning states of a state machine group. Furthermore, non patent documents 2 to 5 describe techniques related to monitoring the status of a system or a network.

### PRIOR ART DOCUMENTS

### Patent Documents

Patent Document 1: Japanese Unexamined Patent Application, First Publication No. 2015-215885
Patent Document 2: Japanese Unexamined Patent Application, First Publication No. 2015-215886
Patent Document 3: Japanese Unexamined Patent Application, First Publication No. 2015-215887

### Non Patent Documents

Non Patent Document 1: Takayuki Kuroda and 7 others, “Acquisition of Knowledge about ICT System Designing with Machine Learning”, IEICE Transactions on Information and Communication Engineers, vol. J104-B, No. 3, pp. 140-151, 2021.
Non Patent Document 2: Zhaowei Xi, and 7 others, “Newton: Intent-Driven Network Traffic Monitoring”, IEEE/ACM Transactions on Networking, DOT: 10.1109/TNET.2021.3128557, 2021.
Non Patent Document 3: Fumio Teraoka and 2 others, “A Study on Network Ontology Bonsai and Its Applications”, IEICE Technical Report IA2021-55 (2022-01), 2022.
Non Patent Document 4: Kengo Tajiri and 3 others, “Dividing Deep Learning Model for Continuous Anomaly Detection of Inconsistent ICT Systems”, NOMS 2020-2020 IEEE/IFIP Network Operations and Management Symposium, 2020.
Non Patent Document 5: K. Abbas and 3 others, “Network Slice Lifecycle Management for 5G Mobile Networks: An Intent-Based Networking Approach”, IEEE Access, vol. 9, DOI: 10.1109/ACCESS.2021.3084834, 2021.

### SUMMARY OF THE INVENTION

### Problems to be Solved by the Invention

It is preferable to provide a criterion for automatically determining whether or not to change a system configuration during operation of the system.

An example of an object of the present invention is to provide a system operation planning device, a display device, a system operation planning method, and a recording medium that can solve the above-mentioned problems.

### Means for Solving the Problem

According to a first example aspect of the present invention, a system operation planning device generates, based on abstract requirements that are information indicating requirements to be satisfied by a target system as a system to be operated, specific requirements that are information indicating requirements to be satisfied by the target system, the specific requirements including information indicating values of each of a plurality of values of a variable factor included in a variable factor range, the information including information indicating a variable factor range as a range of values allowed for a variable factor to take during operation of the target system, the value of the variable factor being a value varying during the operation of the target system and having a correlation with an operation status of the target system.

According to a second example aspect of the present invention, a display device is provided with a display means that displays a list of variable factors whose values change during operation of a target system, which is a system to be operated, and whose values are correlated with the operating status of the target system.

According to a third example aspect of the present invention, a display device is provided with a display means that displays a range of values allowed for a variable factor to take during operation of a target system as a system to be operated, the value of the variable factor being a value varying during the operation of the target system and having a correlation with an operation status of the target system.

According to a fourth example aspect of the present invention, a display device is provided with a display means that displays, in a coordinate space having for each of a plurality of variable factors a coordinate axis, points indicating the values of the variable factor of each coordinate axis indicating values of the variable factor, which varies during the operation of a target system as a system to be operated and has a correlation with an operation status of the target system.

According to a fifth example aspect of the present invention, a system operation planning method executed by a computer, the method includes, based on abstract requirements that are information indicating requirements to be satisfied by a target system as a system to be operated, generating specific requirements that are information indicating requirements to be satisfied by the target system, the specific requirements including information indicating values of each of a plurality of values of a variable factor included in a variable factor range, the information including information indicating a variable factor range as a range of values allowed for a variable factor to take during operation of the target system, the value of the variable factor being a value varying during the operation of the target system and having a correlation with an operation status of the target system.

According to a sixth example aspect of the present invention, a recording medium records a program for causing a computer to, based on abstract requirements that are information indicating requirements to be satisfied by a target system as a system to be operated, generate specific requirements that are information indicating requirements to be satisfied by the target system, the specific requirements including information indicating values of each of a plurality of values of a variable factor included in a variable factor range, the information including information indicating a variable factor range as a range of values allowed for a variable factor to take during operation of the target system, the value of the variable factor being a value varying during the operation of the target system and having a correlation with an operation status of the target system.

### Effect of Invention

According to the present invention, it is possible to provide a criterion for automatically determining whether or not to change a system configuration during operation of the system.

### BRIEF DESCRIPTION OF THE DRAWINGS

FIG. 1 is a block diagram showing an example of the functional configuration of the system operation planning device according to the first example embodiment.

FIG. 2 is a diagram for explaining an overview of the process by which the operation planning portion in the first example embodiment generates an operation plan.

FIG. 3 is a diagram showing an example of expressing abstract requirements in the first example embodiment.

FIG. 4 is a diagram showing an example of a specific requirement in the first example embodiment.

FIG. 5 is a diagram showing an example of a matrix of specific requirements in the first example embodiment.

FIG. 6 is a diagram showing an example of definition information of a variable factor in the first example embodiment.

FIG. 7 is a diagram showing an example of component-type definition information and relationship-type definition information in the first example embodiment.

FIG. 8 is a diagram showing a first example of configuration information in the first example embodiment.

FIG. 9 is a diagram showing a second example of configuration information in the first example embodiment.

FIG. 10 is a diagram showing an example of differential information derived from a configuration pair in the first example embodiment.

FIG. 11 shows an example of a state transition system derived from the differential information illustrated in FIG. 10 in the first example embodiment.

FIG. 12 is a diagram showing an example of component-type definition information including a state transition system definition in the first example embodiment.

FIG. 13 is a diagram showing an example of a configuration change procedure derived from the state transition system in the first example embodiment.

FIG. 14 is a diagram showing an example of an operational plan in the first example embodiment.

FIG. 15 is a flowchart showing an example of the processing steps performed by the operation planning portion according to the first example embodiment.

FIG. 16 is a flowchart showing an example of the processing steps performed by the configuration design portion according to the first example embodiment.

FIG. 17 is a flowchart showing an example of the processing steps performed by the procedure planning portion according to the first example embodiment.

FIG. 18 is a diagram showing an example of a GUI (Graphical User Interface) presented to a user by the operation planning portion according to the first example embodiment.

FIG. 19 is a block diagram showing an example of the functional configuration of the system operation planning device according to the second example embodiment.

FIG. 20 is a diagram figure showing an example of system state information recorded in the state management portion according to the second example embodiment.

FIG. 21 is a flowchart showing an example of the processing steps performed by the operation execution portion according to the second example embodiment.

FIG. 22 is a flowchart showing an example of the processing steps in the operation performed by the operation execution portion of the second example embodiment to maintain the state of the target system in an appropriate state.

FIG. 23 is a flowchart showing an example of the processing steps performed by the determination portion according to the second example embodiment.

FIG. 24 is a block diagram showing an example of the functional configuration of the system operation planning device according to the third example embodiment.

FIG. 25 is a diagram showing an example of the configuration of the system operation planning device according to the fourth example embodiment.

FIG. 26 is a diagram showing an example of the configuration of the display device according to the fifth to seventh example embodiments.

FIG. 27 is a diagram showing an example of processing procedures in the system operation planning method in the eighth example embodiment.

FIG. 28 is a schematic block diagram illustrating the configuration of a computer according to at least one example embodiment.

### EXAMPLE EMBODIMENT

Hereinbelow, example embodiments of the present invention will be described, but the invention according to the claims is not limited to the following example embodiments. Furthermore, not all of the combinations of features described in the example embodiments are necessarily essential to the solutions of the invention.

### First Example Embodiment

In the first example embodiment, a case will be described in which a system operation planning device implements up to the system operation plan. On the other hand, in the second and third example embodiments, a case will be described in which the system operation planning device implements system operation in addition to the system operation plan.

The configuration of the system operation planning device in the first example embodiment shall be described.

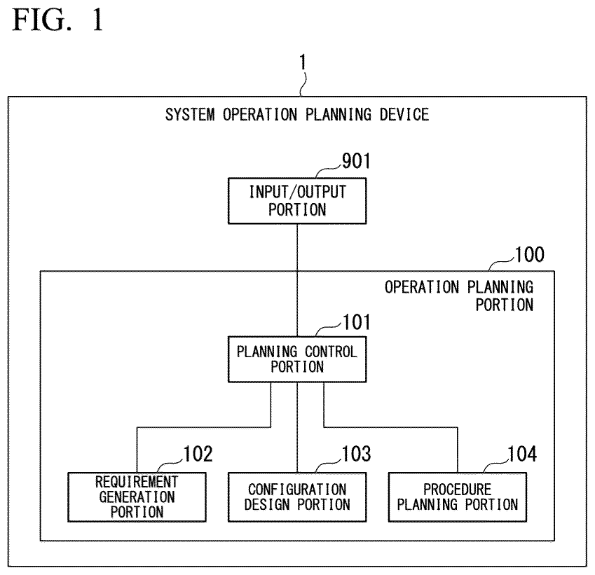

FIG. 1 is a block diagram showing an example of the functional configuration of the system operation planning device according to the first example embodiment.

In the configuration shown in FIG. 1, the system operation planning device 1 is provided with an input/output portion 901 and an operation planning portion 100. The operation planning portion 100 is provided with a planning control portion 101, a requirement generation portion 102, a configuration design portion 103, and a procedure planning portion 104.

The input/output portion 901 is provided with an input/output device, and functions as an interface with a user. The input/output device may be configured by combining an input device such as a keyboard and a mouse with a display device. The input/output portion 901 may have a communication function with other devices in addition to or instead of the function of interfacing with a user.

The input/output portion 901 may be configured as an external input/output device of the system operation planning device 1, and the input/output device and the planning control portion 101 may be capable of communicating with each other.

The operation planning portion 100 accepts abstract requirements input by a user via the input/output portion 901, and outputs an operation plan to the input/output portion 901. Abstract requirements are information that abstractly indicates the requirements for the system that the user wants to construct. An operation plan is information indicating a series of processes for constructing a system that satisfies abstract requirements and operating the constructed system so as to maintain the abstract requirements.

A system for which the system operation planning device 1 generates an operation plan is also called a target system. The operation planning portion 100 generates an operation plan so that the target system satisfies the abstract requirements.

The planning control portion 101 generates an operation plan using the functions of the requirement generation portion 102, the configuration design portion 103, and the procedure planning portion 104 based on the received abstract requirements, and outputs the generated operation plan to the input/output portion 901. The requirement generation portion 102 converts the abstract requirements received from the planning control portion 101 into a matrix of specific requirements and outputs the matrix to the planning control portion 101.

The configuration design portion 103 designs configuration information corresponding to each of the multiple specific requirements received from the planning control portion 101 and outputs the configuration information to the planning control portion 101. The configuration information is information that indicates the system configuration. The configuration design portion 103 corresponds to an example of a configuration design means.

The procedure planning portion 104 plans a procedure for changing a system configuration indicated by a certain piece of configuration information received from the planning control portion 101 to a system configuration indicated by another piece of configuration information, and outputs the procedure to the planning control portion 101. The procedure planning portion 104 corresponds to an example of a procedure planning means.

The abstract requirements, which are input information to the operation planning portion 100, are, as described above, information that indicates the requirements of the system that the user wants to construct, and in particular, information that includes variable factors. A variable factor is a parameter that serves as criteria for selecting the system configuration of the target system and that varies during the operation of the target system. Furthermore, a variable factor is an item whose value changes during operation of the target system 911 and whose value has a correlation with the operating status of the target system 911.

An example of a variable factor is the frequency of access to the target system. In a case where the frequency of access increases, it becomes necessary to increase the computational resources and network resources of the target system so that the target system can withstand a higher load. On the other hand, in a case where the frequency of access decreases, the target system can be operated more efficiently by using fewer resources, thereby saving power and costs.

Thus, the variable factor may be a quantity related to a factor that affects the operation of the target system, such as a factor that places a load on the target system.

Alternatively, the variable factor may be a measured or calculated value relating to the performance of the target system, such as the load factor of the CPU (Central Processing Unit) or the turnaround time of the target system.

In abstract requirements, each variable factor is given a range of allowable values instead of a specific value. This range is also called the variable factor range. The variable factor range is the range within which the value of the variable factor is permitted in a case where the target system 911 is in operation.

On the other hand, a specific requirement is one in which the value of each variable factor is specifically determined based on an abstract requirement. Based on specific requirements, a particular specific system configuration can be designed.

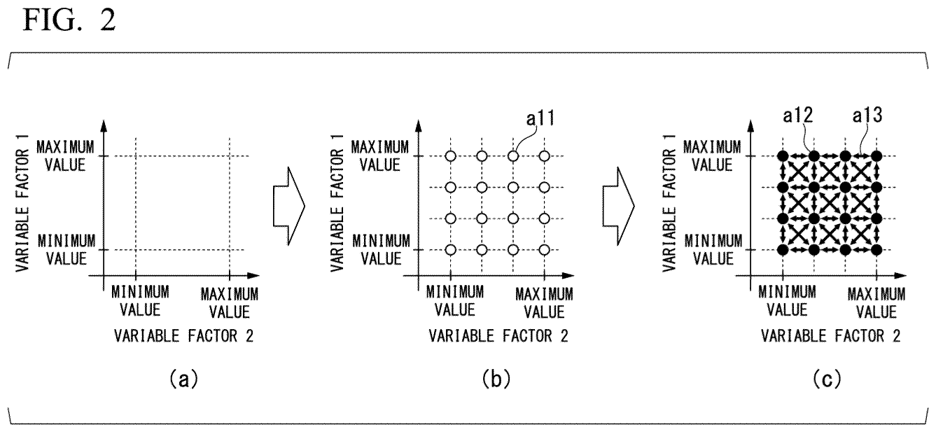

FIG. 2 is a diagram for explaining an outline of the process in which the operation planning portion 100 generates an operation plan.

Part (a) of FIG. 2 shows the variable factors indicated in the abstract requirement and the range of values that each variable factor can take (range from minimum value to maximum value). As noted above, the range of values that the variable factors can take is also indicated in the abstract requirements.

The number of variable factors indicated in an abstract requirement may be one or more, and is not limited to a specific number. That is, in the example shown in FIG. 2, for convenience of explanation, an example is given in which two types of variable factors are represented on a two-dimensional plane, but the variable factors handled by the operation planning portion 100 are not limited to two types.

Part (b) of FIG. 2 shows an example of setting specific requirements in addition to the range of values that the variable factors can take. In part (b) of FIG. 2, specific requirements are indicated by white circles (0), such as white circle all.

The operation planning portion 100 may set the specific requirements. In the example shown in part (b) of FIG. 2, the operation planning portion 100 divides the range of possible values for each variable factor into multiple equal intervals and sets sets of specific variable factor values that correspond to the boundaries of the intervals. By setting sets of specific variable factor values, a matrix of specific requirements can be obtained in which the set values of the variable factors are the values of the variable factors of the original abstract requirements.

However, the method of setting sets of specific variable factor values in setting specific requirements is not limited to a specific method. Furthermore, the arrangement of the sets of specific variable factor values is not limited to a lattice-like arrangement such as the example in part (b) of FIG. 2.

For example, among the range of values that a variable factor can take, the operation planning portion 100 may thin out the sets of specific variable factor values for a portion where the impact of changes in the value of the variable factor on the system configuration is relatively small. In other words, the operation planning portion 100 may thin out specific requirements.

In addition, after the operation planning portion 100 sets a set of specific variable factor values, it may present the set of variable factors that has been set to the user and accept editing of the set of specific variable factor values by the user. For example, the operation planning portion 100 may be configured to accept changes in the positions of, additions to, and deletions of sets of specific variable factor values.

Part (c) of FIG. 2 shows an example of specific configuration information and a configuration change procedure setting, in addition to the range of values that the variable factors can take. In part (c) of FIG. 2, specific configuration information is indicated by a black circle (▪) such as black circle a12, and the settings of the configuration change procedure between the specific configuration information are indicated by an arrow such as arrow a13.

In the example shown in part (c) of FIG. 2, the operation planning portion 110 designs specific configuration information for each specific requirement. Furthermore, the operation planning portion 110 plans a work procedure for changing the configuration from one of two adjacent pieces of configuration information to the other. In this way, the operation planning portion 110 formulates an operation plan.

According to the operation plan generated by the operation planning portion 110, it is expected that it will be possible to determine the appropriate system configuration of the target system based on the values of the variable factors within a specified range of variable factors, and to extract procedures for changing the current system configuration to the appropriate system configuration. It is expected that by changing the system configuration of the target system according to the extracted procedure, the target system can be maintained in an appropriate state.

In order to operate the system based on the operation plan generated by the operation planning portion 110, it is necessary to continuously monitor the values of the variable factors. Therefore, the requirement generation portion 102 inserts the monitoring requirements for each variable factor into a specific requirement. The configuration design portion 103 designs the system configuration of the target system including a monitoring function for each variable factor based on the added monitoring requirements.

Next, data used by the system operation planning device 1 will be described.

In the first example embodiment, the requirements of a target system are described, for example, by abstract configuration information. Abstract configuration information is a general term for configuration information in which some or all of the elements are described by abstract elements, and configuration information in which the designation of other elements on which some or all of the elements depend is omitted. Configuration information is information that indicates the components that make up a system and the relationships between the components.

The parts that make up a system are called components. The relationship between parts is also simply referred to as a relationship. The components and relationships are also collectively referred to as constituent elements. Constituent elements include specific constituent elements and abstract constituent elements.

A specific constituent element is a constituent element whose type can be uniquely identified. An example of a specific constituent element is a component with a defined product name and model number, such as “Tomcat version 1,” which is a type of application server (AppServer).

An abstract constituent element is a constituent element that collectively refers to multiple types of constituent elements. An example of an abstract constituent element is AppServer.

By specifying abstract constituent elements as requirements of the target system, or by omitting to specify other constituent elements on which a certain constituent element depends, it is possible to express conditions including flexibility concisely and accurately, for example, “Any AppServer product will do.” On the other hand, in a case where a system is constructed, the configuration information needs to be specific. That is, all constituent elements must be specific, and other constituent elements on which they depend must be present.

The configuration information can be described with graph-format information with components as nodes and relationships as edges. Each constituent element further includes associated information such as type information indicating its type and properties indicating its attribute values.

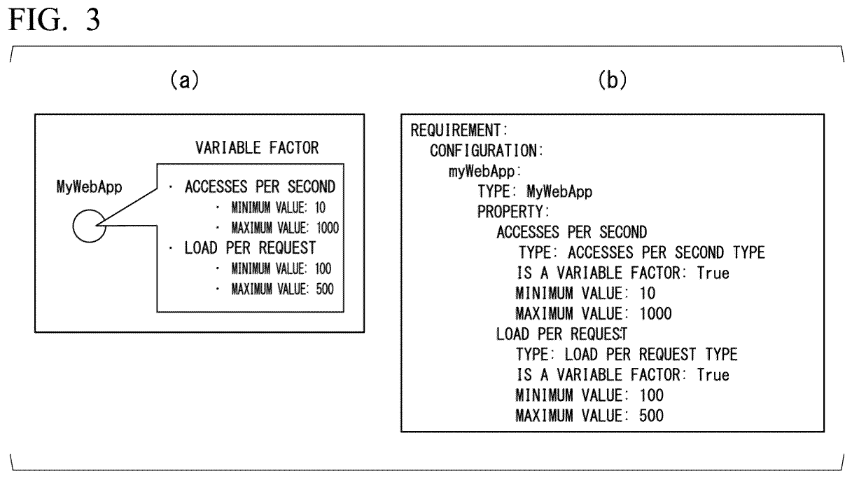

FIG. 3 is a diagram showing an example of expressing an abstract requirement. Part (a) of FIG. 3 shows an example of a graphical representation of an abstract requirement. Part (b) of FIG. 3 shows an example of a textual representation of an abstract requirement.

The abstract requirement configuration illustrated in FIG. 3 includes one component having “myWebApp” as its ID (Identifier). This indicates the user's intent to construct a system on which “myWebApp” runs and to keep “myWebApp” running.

Furthermore, in an abstract requirement, each constituent element can have information on any number of variable factors as properties. In the abstract requirement, for each variable factor, the type of the variable factor and the range of values allowed for the variable factor are specified.

In the abstract requirement example shown in FIG. 3, “myWebApp” contains two properties: “accesses per second” and “load per request”. In part (a) of FIG. 3, these two properties are shown as variables. In part (b) of FIG. 3, these two properties are designated as variable factors by the fact that “is a variable factor” is set to “True.” The range of allowable values for “accesses per second” is specified as 10 to 1000. The range of allowable values for “load per request” is specified as 100 to 500.

As described above, the operation planning portion 100 can generate a matrix of specific requirements based on abstract requirements. The content of each specific requirement is essentially the same as the abstract requirement, but the variables are replaced by general properties and monitoring requirements for the variables, and the values of the properties are assigned specific values rather than a range of values.

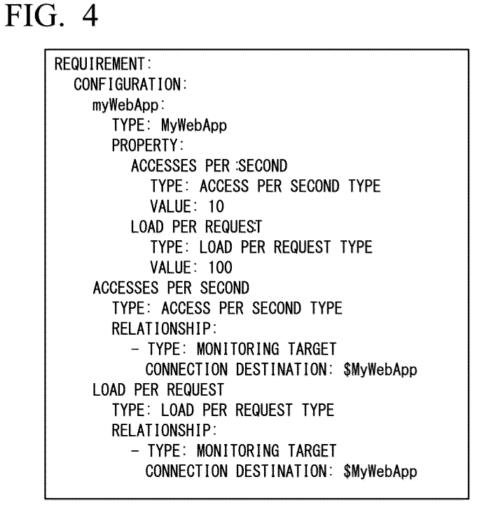

FIG. 4 is a diagram showing examples of specific requirements.

The specific requirements shown in FIG. 4 follow the abstract requirements shown in FIG. 3, but the variables are replaced by general properties and monitoring requirements. The properties derived from the variable factors are “number of accesses per second” and “load per request”. The specific value for “number of accesses per second” is set to 10. A specific value of 100 is set for “load per request”.

Regarding the monitoring requirements for each variable factor, “accesses per second” and “load per request” are shown as components having the function of monitoring each variable factor. The connection relationship between these components and “myWebApp”, where “accesses per second” and “load per request” are the connection source and “myWebApp” is the connection destination, is shown by a monitoring target type relationship. Notations such as “$myWebApp” with a “$” prefix indicate a reference to a component such as “myWebApp”.

A specific requirement including a component having a function of monitoring a variable factor corresponds to an example of a specific requirement including a requirement that the target system 911 includes a configuration for performing observations to obtain a value of the variable factor. In other words, by designing the system configuration of the target system 911 to meet specific requirements, including components having the function of monitoring the variable factors, a system configuration is obtained that includes a configuration for performing observations to obtain the values of the variable factors. Observation here may be a process for obtaining the value of a variable factor or a value related thereto, such as measuring or counting the value of the variable factor or a value related thereto.

The matrix of specific requirements is a set of specific requirements each having a different value for the variable factor.

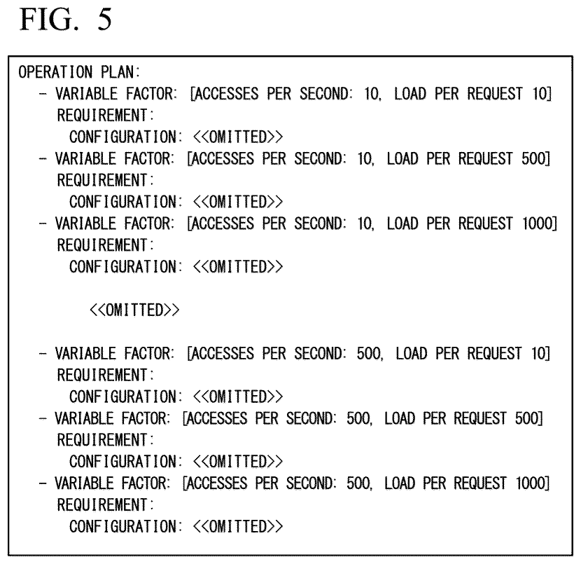

FIG. 5 is a diagram showing an example of a matrix of specific requirements.

In the example shown in FIG. 5, the matrix of specific requirements is defined by an arrangement of specific requirements as part of an operational plan. Each element of the matrix consists of an item “variable factor” and an item “requirement.” In the item “variable factor”, a set of values of the variable factors is defined, and in the item “requirement”, a specific requirement is defined.

As described above, the value of the variable factor of each element of the matrix may be generated by dividing the range of values of the variable factor defined in the abstract requirement into multiple intervals. In the example shown in FIG. 5, the operation planning portion 100 divides each of the two variable factors into two intervals, thereby generating three values for each variable factor, and generates nine sets of values and specific requirements by combining the values of each generated variable factor.

In order to enable the user to define abstract requirements and for the operation planning portion 100 to generate specific requirements based on the abstract requirements, the user defines type information of the variable factors in advance. The type information of a variable factor includes the type name, the value type, the value observation method, the unit of the value, a base value that is a value to be used for configuration at the time of initial construction, and its definition as a component.

The value type in the type information of a variable factor is the type of the value of that variable factor. As the value type, an integer or a Boolean may be specified.

The method for specifying value ranges and the method of dividing the interval of values to generate specific requirements varies from value type to value type. These are predefined for each value type. In the case of integers, a maximum and minimum value can be set and then divided into multiple intervals. In the case of Boolean, there is no particular method for specifying the range, and the division of the interval simply needs to indicate true and false.

The observation method in the type information of a variable factor is the method of observing the value of the variable factor during operation. The observation method may be specified as “monitoring” or “user input”. In a case where the observation method is “monitoring”, it indicates that the value is obtained by monitoring a system in operation. In a case where the observation method is “user input”, it indicates that the user specifies the value of the variable factor via an input/output device.

The “user input” observation method can be used as a changeover switch for the system configuration of the target system in a case where it is known in advance that the user will change some of the requirements required for the target system.

The definition as a component is a definition of the component type in a case where converted into a component indicating a monitoring requirement, and must be set in a case where the observation method is “monitoring.”

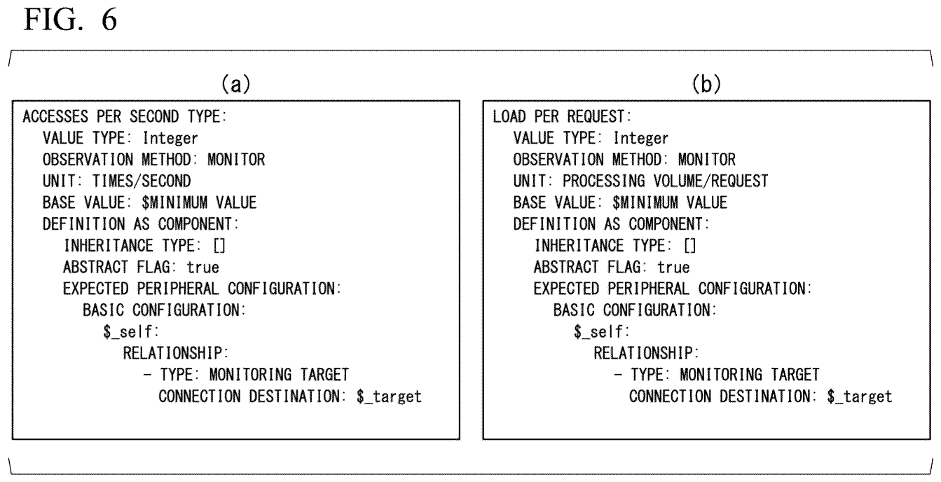

FIG. 6 is a diagram showing an example of definition information of variable factors.

Part (a) of FIG. 6 shows an example of definition information of the “number of accesses per second type.” Part (b) of FIG. 6 shows an example of definition information of “load type per request”.

For both the “accesses per second type” and the “load per request type”, “integer” is set as the “value type” and “monitoring” is set as the “observation method”.

As the “unit” of the value, “times/second” is set for the “number of accesses per second” type, while “processing volume/request” is set for the “load per request” type.

For both the “accesses per second type” and the “load per request type”, “$minimum value” is designated as the “base value”. As described above, the base value indicates the value to be used as the value of the variable factor for the system configuration at the time of initial construction of the target system. “$min” indicates that the minimum value of the variability factor is quoted as defined in the abstract requirement.

The notation method for “definition as a component” is generally similar to the notation method for the definition of a general component type. However, in the “definition as component”, the notation “$_target” is used to refer to the component to which the original variable factor was set.

Using the description of the configuration shown in the “basic configuration” of the “expected peripheral configuration”, a description of the relationships among the components of the specific requirements exemplified in FIG. 4 can be generated.

In the description of the “relationship” of “accesses per second” in FIG. 4, the description of “-type: monitoring target” can be generated by copying the description “-type: monitoring target” in the “relationship” of the definition information of the variable “accesses per second” shown in part (a) of FIG. 6. Also, the description “Connection destination: $myWebApp” in FIG. 4 can be generated by replacing “$_target” in the description of “Connection destination: $_target” of a portion of FIG. 6(a) with “$myWebApp” indicating the target number of accesses per second in the specific requirements shown in FIG. 4.

In order to design configuration information from specific requirements, component type definition information and relationship type definition information are used. Both the component type definition information and the relationship type definition information include information on the inheritance source, abstract flag, property, and definition of the expected peripheral configuration. The relationship type further includes information about the types of components that can be placed on either end of the relationship.

The inheritance source may be set to another constituent element type, and if set, will exhibit the two effects shown below. The first effect is that the constituent element type information being defined is considered to be based on the type information of the constituent element of the inheritance source, and then overwritten by the information indicated in the constituent element type definition of the component being defined. The second effect is that the component being defined is a type of the constituent element of the inheritance source, and is considered to be one of the options for that specific constituent element in a case where the constituent element of the inheritance source is specified in a requirement. That is, in a case where designing configuration information based on a requirement for which the inheritance source component is specified, there are cases in which the constituent element on the inheriting side is adopted as a specific constituent element. The abstract flag is a flag that indicates whether the constituent element is abstract or specified. The properties are the types and values of attributes that the constituent element has. The expected peripheral configuration is a peripheral configuration that must be satisfied in order for the constituent element to function correctly and multiple variations may be set.

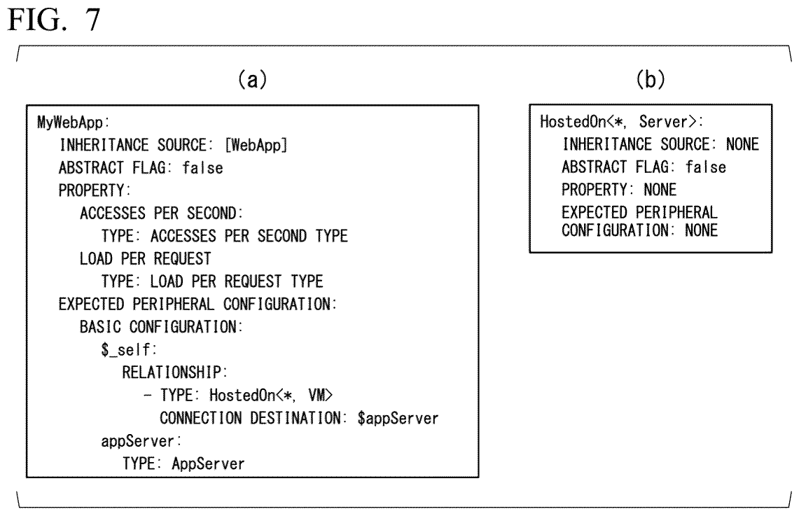

FIG. 7 is a diagram showing an example of component type definition information and relationship type definition information.

In part (a) of FIG. 7, definition information of the component of type “MyWebApp” is shown as an example of definition information of a component type. In part (b) of FIG. 7, definition information of a relationship of type “HostedOn<*, Server>” is shown as an example of definition information of a relationship type.

In the example shown in part (a) of FIG. 7, “WebApp” is set as the inheritance source of the “MyWebApp” type. Because the abstract flag is set to “false”, components of type “MyWebApp” are treated as specific constituent elements. The properties of the “MyWebApp” type component are defined as “number of accesses per second” and “load per request”. Moreover, only the “basic configuration” is specified as the expected peripheral configuration. The “basic configuration” indicates that the relevant constituent element (the component to be defined) must be connected to the “AppServer” type constituent element through a HostedOn<*, VM> type relationship. Note that “$_self” indicates the constituent element itself.

In the example shown in part (b) of FIG. 7, the “HostedOn<*, Server>” type relationship specifies that the connection source type is “*” and the connection destination type is “Server.” “*” denotes any type. The “abstract flag” is set to “false”. In addition, “inheritance source”, “properties” and “expected peripheral configuration” are all set to “none”.

The configuration information is information in graph form that is expressed by components and their relationships, and all components are specific and the expected peripheral configuration is satisfied.

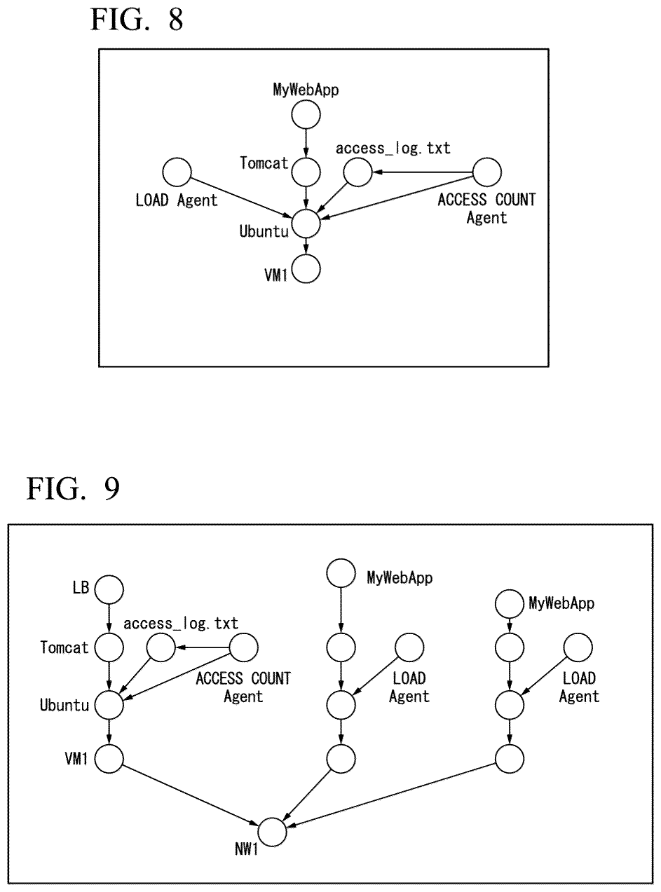

FIG. 8 is a diagram illustrating a first example of configuration information.

In the example shown in FIG. 8, MyWebApps is connected to Tomcat, which is a type of Application Server, through the relationship HostedOn<*, AppServer>. Tomcat is similarly connected to Ubuntu, a specific OS. Additionally Ubuntu is similarly connected to a specific Virtual Machine (VM), VM1.

The function of monitoring the number of accesses per second is embodied as the access count agent that monitors access_log.txt, one of the Tomcat execution logs. The access count agent is connected to each of access_log.txt and Ubuntu.

The function that monitors load per request is embodied as the load agent, which is an agent that measures the processing amount of specific processes on Ubuntu. The load agent is connected to Ubuntu.

The first example of configuration information shown in FIG. 8 indicates a small-scale system configuration in which MyWebApp is realized by a single virtual machine. This system configuration is assumed to be a system configuration generated from specific requirements, for example, the value of the variable factor being 10 accesses per second and the load per request being 10.

FIG. 9 is a diagram illustrating a second example of the configuration information.

The system configuration shown in the second example of configuration information has a basic structure similar to that of the first example of configuration information, but MyWebApp is configured redundantly with two virtual machines, and a load balancer (LB) is provided in the front stage. The monitoring function is configured to measure the number of accesses per second to the load balancer and the load per request for each MyWebApp.

Next, data related to planning the procedure for changing from one system configuration to another will be described.

In a case where planning a configuration change procedure, the operation planning portion 100 first generates configuration difference information, which is information about the difference between two system configurations. The configuration difference information is also simply referred to as difference information.

Next, the operation planning portion 100 generates information on a state transition system based on the system configurations and the difference therebetween. The operation planning portion 100 calculates and derives a state transition procedure for transitioning from a current state to a target state with the fewest number of state transitions, based on information about the state transition system. The current state indicates the system configuration before the configuration change. The target state indicates the system configuration after the configuration change.

Difference information is information in which labels such as newly added, maintain status quo, or delete are added to each constituent element in the configuration information created by integrating, without overlap, the constituent elements included in the configuration information indicating the current system configuration and the constituent elements included in the configuration information indicating the desired system configuration. The current system configuration corresponds to the system configuration before the configuration change. The desired system configuration corresponds to the system configuration after the configuration change.

The label here indicates information such as newly added, maintain status quo, or deletion. The labels are added based on the state of each constituent element in the current system configuration and the state of each constituent element in the desired system configuration. For example, a label of newly added is added to a constituent element that is not included in the current system configuration but is included in the desired system configuration. Constituent elements that are included in both the current system configuration and the desired system configuration are labeled as “maintain status quo.” Constituent elements that are included in the current system configuration but not in the desired system configuration are labeled for deletion.

Additionally, a label such as update may be provided. If the update label is included, among the constituent elements included in both the current system configuration and the desired system configuration, those constituent elements whose property values are the same are labeled as “maintain status quo,” while those whose property values have changed are labeled as “update.” In the following examples, for simplicity, update labels will not be addressed.

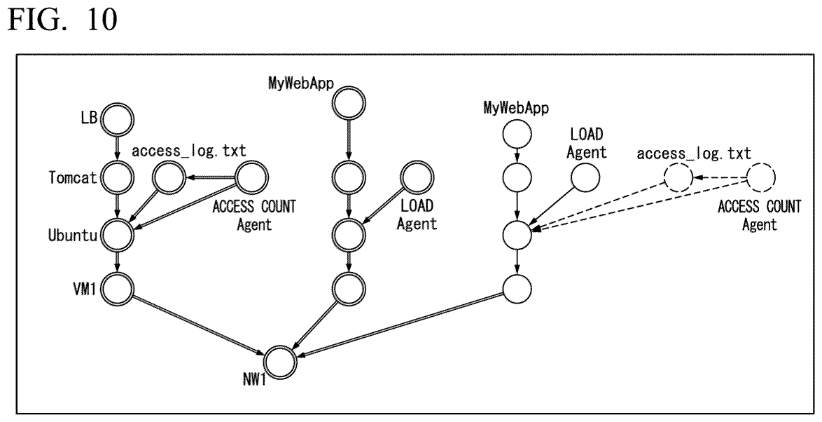

FIG. 10 is a diagram illustrating an example of difference information derived from a configuration pair.

A configuration pair is a pairing of a current system configuration and a desired system configuration. FIG. 10 shows an example of difference information in a case where the system configuration shown in FIG. 8 is the current system configuration and the system configuration shown in FIG. 9 is the desired system configuration.

In FIG. 10, different labels are expressed by different line types. Constituent elements drawn with a solid single line are constituent elements to be maintained as is. Constituent elements drawn with double solid lines are newly added constituent elements. Constituent elements drawn with dotted lines are constituent elements to be deleted.

The state transition system information is information that associates possible states of each constituent element included in the configuration information and the state transitions that can arise through dependencies, and indicates the current state and target state of each constituent element. In the state transition system information, each constituent element has information on an arbitrary number of states and possible transitions between any pair of states.

In addition, dependencies can be defined for state transitions in each constituent element. A dependency is specified from a state transition in a certain constituent element to a specific state in another constituent element, and expresses a condition that the former transition can be executed only in the state of the latter. The conditions under which a transition is executed may be specified by the states of multiple constituent elements.

The current and target states of each constituent element can be determined based on the constituent element's label. Rules that indicate the relationship between the label and the current and target states are determined in advance, and so the current and target states can be determined according to the label in accordance with these rules.

For example, if a component has two states, “on” and “off,” and if it is a newly added component, the current state is “off” and the target state is “on.” For a maintain status quo component, both the current state and the target state are assumed to be “on.” If it is a component for deletion, the current state is “on” and the target state is “off”.

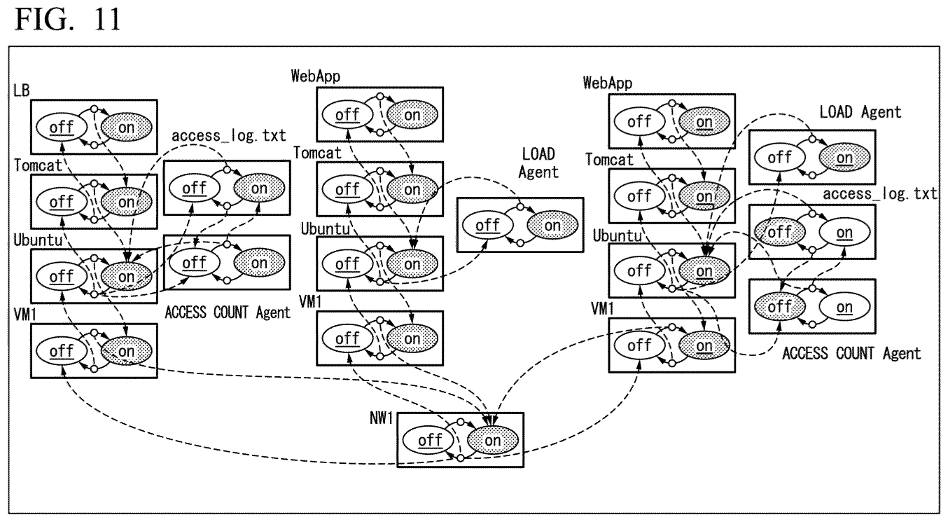

FIG. 11 shows an example of a state transition system derived from the difference information shown in FIG. 10. In the example shown in FIG. 11, all components have two states: “on” and “off.” On the other hand, in the example shown in FIG. 11, the relationship does not have a state transition system.

In FIG. 11, the state transition system of one constituent element is shown in one rectangle. The ellipses indicate the states. A solid arrow connecting two ellipses indicates a state transition. Dashed arrows drawn from state transitions to states indicate dependencies.

The letters in the respective ellipses indicate the names of the states. If a state's name is underlined, it indicates that the state is the current state. A black ellipse indicates that the state is a destination state. In the difference information, the current state of the newly added constituent element is “off” and the target state is “on.” The current state and the target state of a constituent element that is labelled as “maintain status quo” in the difference information are both “on”. The current state of a constituent element to be deleted in the difference information is “on” while the target state is “off.”

The content of the state transition system of each constituent element and the dependencies between state transition systems can be defined in the type information of each constituent element. For example, in the type information of a constituent element, in addition to the content of the constituent element type, information on the state transition system and state dependency may be further defined.

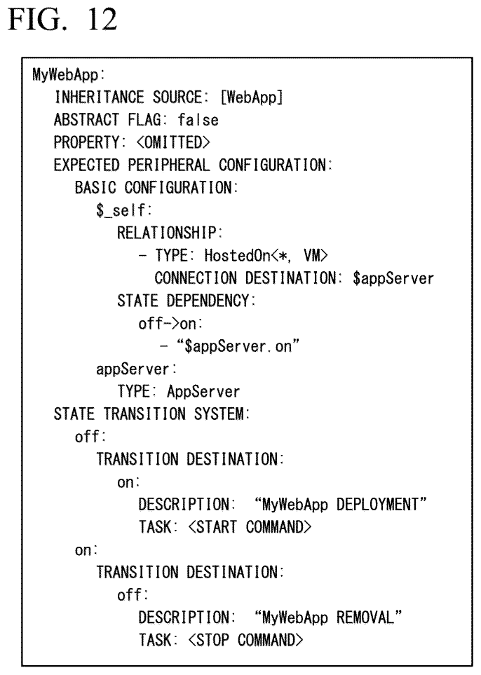

FIG. 12 is a diagram showing an example component type definition information including a definition of a state transition system.

The “MyWebApp” type component shown in FIG. 12 includes a definition of a state transition system, with “off” and “on” defined as states. The state definition indicates information about the transition destination for each state. “On” is defined as the transition destination from “off”. “Off” is defined as the transition destination from “on”.

For each transition destination, a description and a task are further defined as information about the transition from the source state to the transition destination state. For example, the description of the transition from “off” to “on” includes “Deploying MyWebApp,” and a launch command is set as the task. Similarly, the description of the transition from “on” to “off” states “Remove MyWebApp”, with a stop command being set as the task.

Also, state dependency is specified in the item “expected peripheral configuration”. Specifically, it is specified that the state transition of MyWebApp itself from “off” to “on” depends on the appServer on which MyWebApp is deployed being in the “on” state. “$_self” represents the component being defined itself. The statement “off->on” represents a state transition from the “off” state to the “on” state. The statement “$appServer.on” represents the “on” state of the constituent element referenced by “$appServer”. The fact that appServer is the deployment destination of MyWebApp is expressed by specifying “$appServer” as the connection destination of the HostedOn<*, VM> type relationship as the relationship of “$_self”.

By using the contents of the state transition system of each constituent element and information on the dependencies between the state transition systems, it is possible to derive information on the state transition system from the difference information. That is, it is sufficient to introduce a state transition system provided by each constituent element indicated in the difference information, and add dependencies between the state transition systems based on the state dependency specification.

A configuration change procedure is information in which a plurality of tasks are linked by dependencies between the tasks, and can be represented by a directed acyclic graph.

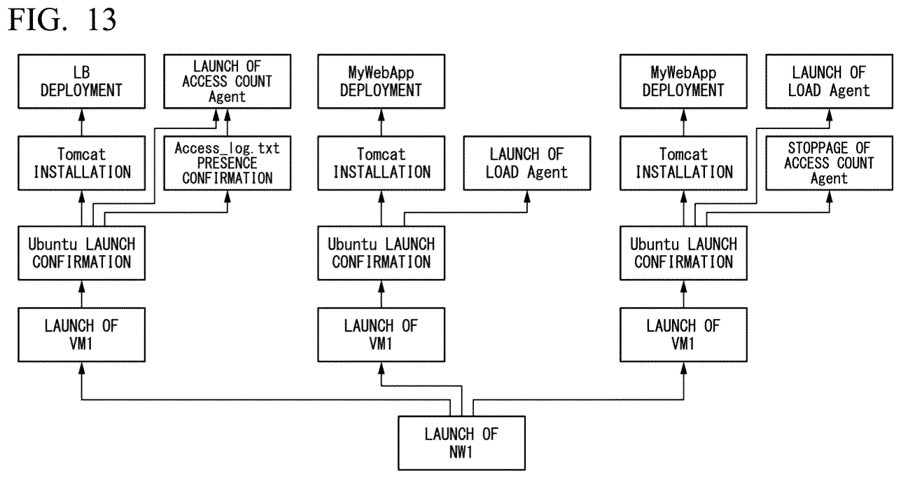

FIG. 13 is a diagram illustrating an example of a configuration change procedure derived from a state transition system.

In the example shown in FIG. 13, rectangles represent tasks, and solid arrows drawn between tasks represent the order in which the tasks are performed.

In the example shown in FIG. 13, it is instructed that “NW1 launch” is to be performed first. Next, instructions are given to execute tasks related to each virtual machine in sequence. No dependencies are shown between the tasks associated with each virtual machine, indicating that these tasks can be performed in parallel.

By using information about the state transition system, it is possible to calculate the procedure for converting from the current system configuration to the desired system configuration. In other words, it is only necessary to calculate the shortest state transition procedure that transitions the states of the state transition systems of all constituent elements from the current state to the target state while satisfying the dependencies. It is shown in Patent Document 2 that this problem is reduced to a certain type of shortest path search problem.

The tasks defined for each transition appearing in the derived state transition procedure are introduced, and dependencies are also added in the information on the configuration change procedure to the tasks between state transition systems that are related by dependencies in the information on the state transition system.

The operation plan is information that integrates the above variable factors, requirements, system configuration, and configuration change procedures.

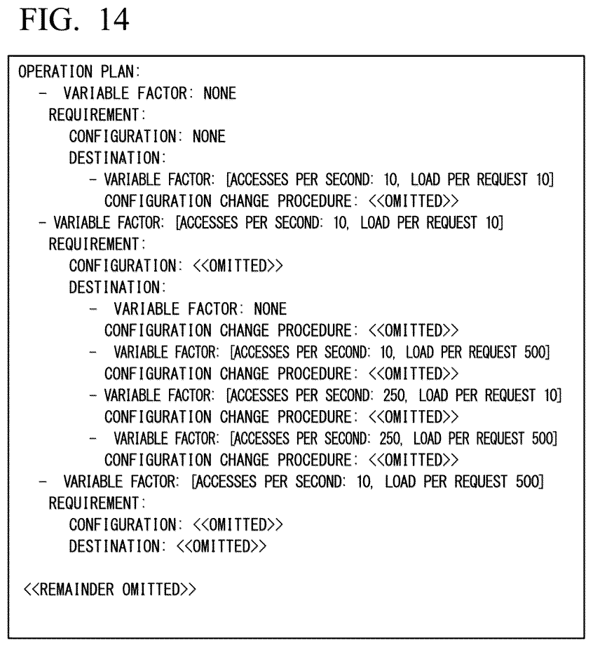

FIG. 14 is a diagram illustrating an example of an operation plan.

Among the elements of the operation plan shown in FIG. 14, the elements with “none” in the variable factor and configuration indicate the initial state before the system is constructed.

In the operation plan, a set of variable factor values is associated one-to-one with a system configuration. Therefore, the set of values of the variable factors shown for each system configuration in an operation plan is unique within one operation plan and serves as an ID for each system configuration.

In a case where specifying another system configuration to be changed from each system configuration, a set of values of the variation factors is used as the ID of the system configuration to be changed. By identifying the set of variable factor values that become the ID of the original system configuration and the set of variable factor values that become the ID of the change destination system configuration, the configuration change procedure to be used for the change can be read from the operation plan.

Of the above data, the data that is input by a person are the abstract requirements, the definition information of the constituent element type, and the variable factor definition information, with the other data being automatically generated.

Next, the operation of the system operation planning device 1 will be described.

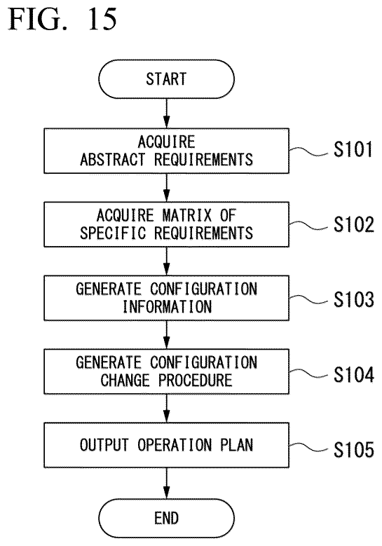

FIG. 15 is a flowchart showing an example of a procedure of processing performed by the operation planning portion 100.

In the process shown in FIG. 15, the planning control portion 101 acquires abstract requirements input by a user via the input/output portion 901 (Step S101). The planning control portion 101 outputs the acquired abstract requirements to the requirement generation portion 102, and the requirement generation portion 102 generates a matrix of specific requirements from the acquired abstract requirements (Step S102).

In a case where generating a matrix of specific requirements from abstract requirements, the requirement generation portion 102 first extracts variable factors contained in the abstract requirements, and divides the range between the minimum and maximum values into a plurality of intervals. The range should be divided equally into a predetermined number of intervals.

However, as described above, the method of setting the specific set of variable factor values is not limited to a specific method. Furthermore, the arrangement of the sets of specific variable factor values is not limited to a lattice-like arrangement such as the example in part (b) of FIG. 2.

For example, among the range of values that a variable factor can take, the operation planning portion 100 may thin out the sets of specific variable factor values for a portion where the impact of changes in the value of the variable factor on the system configuration is relatively small. In other words, the operation planning portion 100 may thin out specific requirements.

In addition, after the operation planning portion 100 sets a set of specific variable factor values, it may present the set of variable factors that has been set to the user and accept editing of the set of specific variable factor values by the user. For example, the operation planning portion 100 may be configured to accept changes in the positions of, additions to, and deletions of sets of specific variable factor values.

Next, the requirement generation portion 102 generates a matrix made up of values that are the boundaries between intervals. After performing this for each variable factor, the requirement generation portion 102 generates an array of value sets that is a Cartesian product of arrays of a plurality of values. The requirement generation portion 102 converts the abstract requirement into a specific requirement using each obtained set of values. That is, the requirement generation portion 102 converts each variable factor included in the abstract requirement into a general property, and inserts, as a value, a value corresponding to each variable factor from the set of values. In addition, the requirement generation portion 102 adds monitoring requirements for each variable factor to the configuration information defined in the abstract requirements based on the definition of the variable factor as a constituent element defined in its type and information on the expected peripheral configuration.

Next, the configuration design portion 103 generates configuration information from each specific requirement (Step S103). The procedure planning portion 104 generates a configuration change procedure from each pair of constituent elements (Step S104).

In a case where extracting pairs of constituent elements, the procedure planning portion 104 may pair a certain set of variable factor values with one or more variable factor values that differ by one level. In addition, the procedure planning portion 104 generates an initial configuration in which the variable factors and constituent elements are “none,” and plans a configuration change procedure with the underlying specific requirements such that the values of all the variable factors are the base values.

Then, the planning control portion 101 generates an operation plan that links each specific requirement in the obtained matrix of specific requirements, configuration information that satisfies that specific requirement, and configuration change procedures for each other configuration information that is paired with that configuration information, and outputs the operation plan to the user via the input/output portion 901 (Step S105).

After Step S105, the operation planning portion 100 ends the processing of FIG. 15.

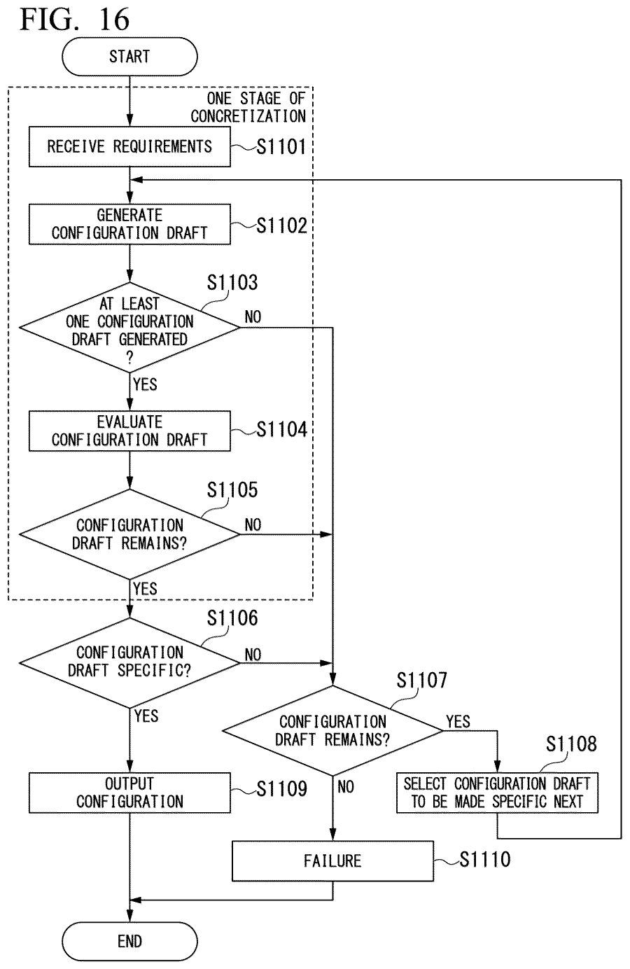

FIG. 16 is a flowchart showing an example of a procedure of processing performed by the configuration design portion 103.

In the process of FIG. 16, the configuration design portion 103 acquires specific requirements from the planning control portion 101 (Step S1101). Next, the configuration design portion 103 gradually clarifies the specific requirements (Steps S1102 to S1108). The configuration design portion 103 outputs the completely embodied configuration information to the planning control portion 101 (Step S1109).

After Step S1109, the configuration design portion 103 ends the processing in FIG. 16.

In the process of instantiating specific requirements in stages, the configuration design portion 103 performs one stage of concretization (steps S1102 to S1105). Then, the configuration design portion 103 determines whether or not a specific configuration draft is included in the obtained multiple configuration drafts (Step S1106).

Here, the configuration draft refers to configuration information that is in the process of being made specific. A configuration draft is deemed specific if all of the constituent elements it contains are specific. Each constituent element is determined to be specific if two conditions are met: the value of the abstract flag for that type is “true” and the expected peripheral configuration is satisfied.

If it is determined in Step S1106 that a specific configuration draft is included (Step S1106: YES), the configuration design portion 103 outputs the specific configuration draft to the planning control portion 101 as configuration information (Step S1109).

After Step S1109, the configuration design portion 103 ends the processing in FIG. 16.

On the other hand, if it is determined in Step S1106 that a specific configuration draft is not included (Step S1106: NO), the configuration design portion 103 determines whether or not an abstract configuration draft remains in the configuration draft tree (Step S1107).

Here, a configuration draft tree is data with a tree structure in which configuration drafts are nodes, and in a case where one configuration draft is made specific to generate another configuration draft, the former configuration draft has the latter configuration draft as a child.

If it is determined that an abstract configuration draft remains (Step S1107: YES), the configuration design portion 103 appropriately selects the next configuration draft to be made specific (Step S1108). After Step S1108, the process returns to Step S1102, and the configuration design portion 103 performs one stage of instantiation again.

On the other hand, if it is determined in Step S1107 that no abstract configuration draft remains (Step S1107: NO), the configuration design portion 103 determines that the system design has failed (Step S1110). This is because the design cannot be considered any further.

After Step S1110, the configuration design portion 103 ends the processing in FIG. 16.

In one-stage instantiation, the configuration design portion 103 generates one or more configuration drafts by selecting and instantiating one of the abstract constituent elements contained in the specific requirement input in Step S1101 or the configuration draft selected in Step S1108 to be specified next (Step S1102).

The instantiation of an abstract constituent element means either instantiating a type of that constituent element or applying an expected peripheral configuration. Instantiation of a component type is performed in a case where the type of the constituent element to be instantiated is an abstract constituent element type, and is an operation to replace the constituent element type with a more specific type. In this case, the component type to be replaced is limited to a component type that has the component type before replacement as the inheritance type.

Next, the configuration design portion 103 determines whether or not one or more configuration drafts have actually been generated in Step S1102 (Step S1103). If it is determined that a configuration draft has not been generated (Step S1103: NO), the process proceeds to Step S1107. In this case, since the configuration design portion 103 has failed to generate a new configuration draft in Step S1102, it determines whether or not there are other configuration drafts remaining on the configuration draft tree.

On the other hand, if it is determined in Step S1103 that one or more configuration drafts have been generated (S1103: YES), the configuration design portion 103 evaluates each of the generated configuration drafts and excludes from the configuration drafts to be processed those that are abstract and cannot be further made specific (Step S1104).

Then, the configuration design portion 103 determines whether or not any configuration draft to be processed remains among the configuration drafts generated in Step S1103 (Step S1105).

If the configuration design portion 103 determines that there remains a configuration draft to be processed (Step S1105: YES), the process proceeds to Step S1106. On the other hand, if the configuration design portion 103 determines that there are no configuration drafts remaining to be processed (Step S1105: NO), the process proceeds to Step S1107.

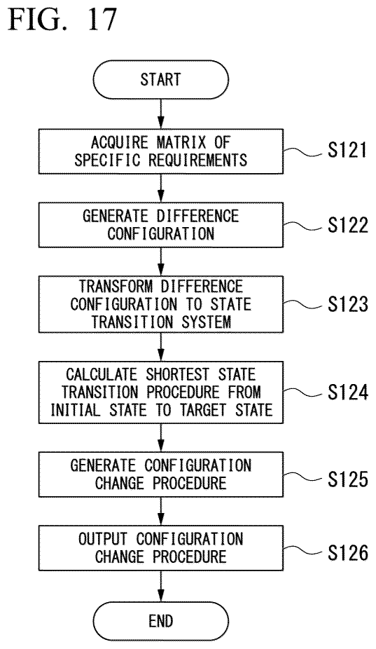

FIG. 17 is a flowchart showing an example of a procedure of processing performed by the procedure planning portion 104.

In the process of FIG. 17, the procedure planning portion 104 acquires a matrix of specific requirements from the planning control portion 101 (Step S121). Then, the procedure planning portion 104 generates difference information based on the matrix of specific requirements (Step S122).

Specifically, the procedure planning portion 104 generates pairs of two sets of variable factor values, in which the values of one or more variable factors differ by one level, from the sets of variable factor values included in the matrix of specific requirements. Then, the procedure planning portion 104 generates difference information by adding labels such as newly add, maintain status quo, and delete to each component in the configuration information created by integrating the two pieces of configuration information belonging to the generated pair, as described above. The procedure planning portion 104 generates difference information for each pair of two variable factor values included in the matrix of specific requirements, in which the values of one or more variable factors differ by one level.

Next, the procedure planning portion 104 generates a state transition system based on each of the difference information and the constituent element type information (Step S123).

Next, the procedure planning portion 104 calculates the shortest state transition procedure for transitioning all states of the state transition system from the initial state to the target state (Step S124). Then, the procedure planning portion 104 generates a configuration change procedure by arranging processes for configuration change according to the calculated state transition procedure (Step S125). The procedure planning portion 104 outputs the generated configuration change procedure to the planning control portion 101 (Step S126).

After Step S126, the procedure planning portion 104 ends the process of FIG. 17.

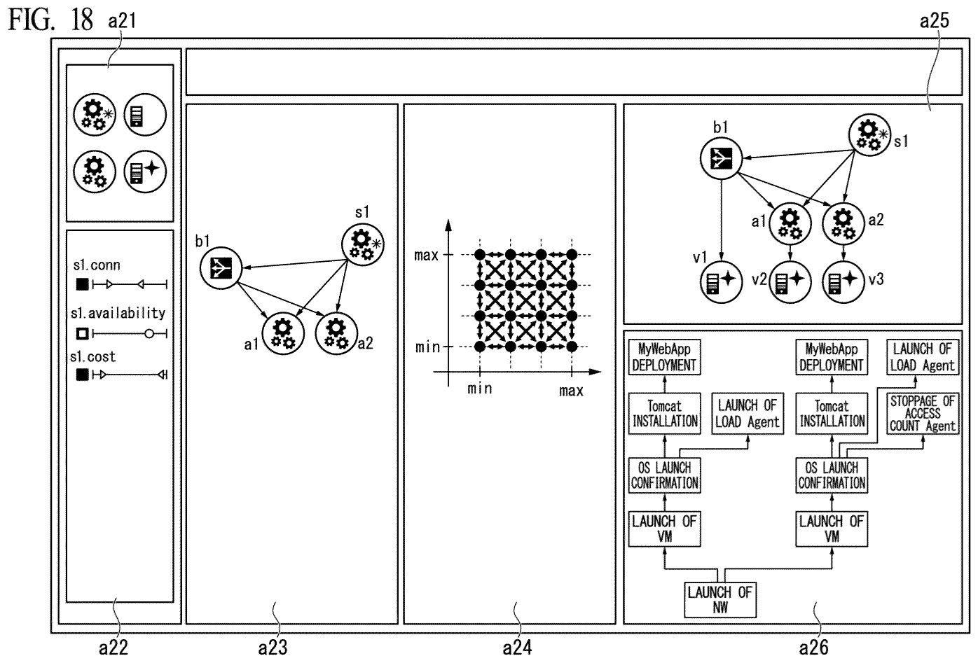

FIG. 18 is a diagram showing an example of a GUI (Graphical User Interface) that the operation planning portion 100 presents to the user. The input/output portion 901 displays an operation screen, such as that shown in FIG. 18, in accordance with the control by the operation planning portion 100, and accepts user operations.

The input/output portion 901 corresponds to an example of a display means. The input/output portion 901 corresponds to an example of an operation input means. The system operation planning device 1 corresponds to an example of a display device.

The operation screen shown in FIG. 18 includes a display area (area a21) for a list of selectable components, a display area (area a22) for selecting variable factors and for adjusting values, a requirements editing pane (area a23), an operation plan confirmation pane (area a24), a configuration information confirmation pane (area a25), and a configuration change procedure confirmation pane (area a26).

In the requirements editing pane (area a23), the user can edit the requirements that the target system must satisfy by using the mouse to drag and drop components from the display area (area a21) that lists the selectable components to draw an abstract system configuration.

Each variable factor included in the components in the system configuration drawn in the requirement editing pane (area a23) is displayed as a list in the variable factor selection and value adjustment bar display area (area a22). By checking the checkboxes, the user selects the variable factors to be used for configuration change from among the variable factors displayed in the variable factor selection and value adjustment bar display area (area a22). Then, the user sets the maximum and minimum values of the selected variable factor using the adjustment bar.

The display of a list of variable factors in the variable factor selection and value adjustment bar display area (area a22) corresponds to an example of displaying a list of variable factors.

The display of the maximum and minimum values of each variable factor in the variable factor selection and value adjustment bar display area (area a22) corresponds to an example of the display of the range within which the value of the variable factor is permissible during operation of the target system 911.

An overview of the generated operation plan is displayed in the operation plan confirmation pane (area a24). In a case where any specific configuration information in the operation plan is clicked, the system configuration corresponding to that specific configuration information is displayed in the configuration information confirmation pane (area a25). As in FIG. 2, specific configuration information is indicated by black circles.

The user may be able to adjust the values of the variable factors used as the reference values for system configuration changes by editing the specific requirements displayed in the operation plan confirmation pane (area a24). For example, a user may be able to move, add, or delete specific requirements.

Here, as described above, the number of variable factors is not limited to two. In a case where the number of variable factors is three or more, the input/output portion 901 may display the operation plan multidimensionally. For example, the input/output portion 901 may display the operation plan stereoscopically (three-dimensionally) based on three variable factors. In this case, the input/output portion 901 may display the three-dimensional operation plan so that the line of sight direction is changeable.

Alternatively, the user may be allowed to select two of the three or more variable factors, and the input/output portion 901 may display an operation plan in a planar (two-dimensional) manner for the two selected variable factors.

At a stage before the configuration design portion 103 performs system design, the input/output portion 901 may display a combination of variable factors and accept editing by the user in the same manner as described above.

In a case where any configuration change procedure in the operation plan displayed in the operation plan confirmation pane (area a24) is clicked, the contents of that configuration change procedure are displayed in the configuration change procedure confirmation pane (area a26). As in FIG. 2, the configuration change procedure is indicated by arrows.

The display of the operation plan in the operation plan confirmation pane (area a24) corresponds to an example of displaying points indicating the values of the variable factors for each coordinate axis in a coordinate space having coordinate axes indicating the values of the variable factors for each of a number of variable factors.

Next, the effects of the first example embodiment will be described.

According to the first example embodiment, the process of formulating a series of operation plans including configuration changes according to values of variable factors is automated. In addition, a series of configuration information and configuration change procedures are planned before actual operation begins, so configuration changes can be implemented quickly and reliably in a case where a response is required.

The user may refer to the configuration change procedure and carry out the configuration change. Alternatively, like the system operation planning device in the second example embodiment, the device may automatically or semi-automatically carry out the configuration change.

As described above, the requirement generation portion 102 generates specific requirements, which are information indicating the requirements that the target system 911 should satisfy, based on abstract requirements, which include information indicating a variable factor range, which is a range within which the values of variable factors that are values that change during operation of the target system 911, which is the system to be operated and are correlated with the operating status of the target system 911, are permissible during operation of the target system 911, and which include information indicating the values for each of the multiple values of the variable factors included in the variable factor range.

According to the system operation planning device 1, the values of the variable factors indicated by each of multiple specific requirements can be used as a judgment criterion for automatically determining whether or not to change the system configuration of the target system 911 during operation of the target system 911. By designing a system configuration that satisfies specific requirements, it is possible to obtain a system configuration that is suitable in a case where the current variable factor value is the value of the variable factor indicated by the specific requirement or a value lower than that value. Therefore, by selecting a specific requirement whose variable factor value is greater than the current variable factor value and designing a system configuration that satisfies that specific requirement, it is possible to obtain a system configuration that is suitable for the current variable factor value.

Furthermore, by selecting a specific requirement with the smallest variable factor value from among the specific requirements with variable factor values greater than the current variable factor value and designing a system configuration that satisfies that specific requirement, it is possible to obtain the smallest system configuration among the system configurations that are suitable for the current variable factor value. By constructing or updating the target system 911 according to this system configuration, the target system 911 can be operated efficiently.

It should be noted that, here, the larger the value of the variable factor, the higher the performance of the target system 911. For variable factors for which the smaller the value of the variable factor, the higher the performance of the target system 911, in the explanation of the selection of the factor level, “large” should be read as “small”.

In the system operation planning device 1, the variable factors are not limited to those in a specific field. According to the system operation planning device 1, it is possible to obtain decision criteria for automatically determining whether or not to change the system configuration of the target system 911 for various fields of target systems 911.

Furthermore, the requirement generation portion 102 generates specific requirements including a requirement that the target system 911 include a configuration for performing observations to obtain values of variable factors.

According to the system operation planning device 1, the target system 911 is configured to acquire variable factor values, and it is expected that the system configuration of the target system 911 can be changed using the values of the variable factors acquired by the target system 911.

Furthermore, the configuration design portion 103 generates, for each of the specific requirements, configuration information indicating the system configuration of the target system that satisfies that requirement.

According to the system operation planning device 1, it is possible to determine the system configuration after changing the system configuration of the target system 911 based on the variable factor values. Specifically, a specific requirement that corresponds to the current variable factor value can be selected, and the system configuration that satisfies that requirement can be made the system configuration after the change of the system configuration of the target system 911.

The specific requirement corresponds to the current variable factor value in a case where the value of the variable factor indicated in the specific requirement is greater than the current variable factor value. As described above, it is also possible to select a specific requirement with the smallest variable factor value from among specific requirements with variable factor values greater than the current variable factor value.

As above, here too, the larger the value of the variable factor, the better the performance of the target system 911. For variable factors for which the smaller the value of the variable factor, the higher the performance of the target system 911, in the explanation of the selection of the factor level, “large” should be read as “small”.

Furthermore, the procedure planning portion 104 generates a configuration change procedure, which is information indicating a procedure for changing from a system configuration indicated by one of the configuration information to a system configuration indicated by another of the configuration information.

According to the system operation planning device 1, the system configuration of the target system 911 can be changed according to the configuration change procedure generated by the procedure planning portion 104.

In addition, the planning control portion 101 generates an operation plan that is information that includes information linking each specific requirement with a configuration change procedure that indicates the procedure for changing the system configuration of the target system 911 to a system configuration that satisfies that requirement.

According to the system operation planning device 1, it is possible to change the system configuration of the target system 911 by referring to the operation information. Specifically, from the specific requirements contained in the operational information, a specific requirement that corresponds to the current variable factor value can be selected, and the system configuration that satisfies that requirement can be made the system configuration after the system configuration of the target system 911 is changed.

As in the above, here too, a specific requirement corresponds to the current variable factor value in a case where the value of the variable factor indicated in the specific requirement is greater than the current variable factor value. As described above, it is also possible to select a specific requirement with the smallest variable factor value from among specific requirements with variable factor values greater than the current variable factor value.

As above, here too, the larger the value of the variable factor, the better the performance of the target system 911. For variable factors for which the smaller the value of the variable factor, the higher the performance of the target system 911, in the explanation of the selection of the factor level, “large” should be read as “small”.

The input/output portion 901 also displays a list of variable factors whose values change during operation of a target system 911, which is the system to be operated, and whose values have a correlation with the operating status of the target system.

According to the system operation planning device 1, a user can refer to the list of variable factors and select, from among the variable factors, a variable factor to be used as a criterion for determining whether or not to change the system configuration of the target system 911.

Furthermore, the input/output portion 901 accepts a user operation designating a variable factor, from among the variable factors shown in the list of variable factors, to be used to determine whether or not a change is required to the system configuration of the target system during operation of the target system.

According to the system operation planning device 1, a user can indicate the variable factor to be used in determining whether or not a change is required for the system configuration of the target system by performing a relatively simple operation of selecting, from the variable factors shown in the list of variable factors, the variable factor to be used in determining whether or not a change is required for the system configuration of the target system during operation of the target system.

In addition, the input/output portion 901 displays a range of values allowed for a variable factor to take during operation of the target system 911 as the system to be operated, the value of the variable factor being a value varying during the operation of the target system 911 and having a correlation with an operation status of the target system.

According to the system operation planning device 1, a user can refer to the display by the target system 911 and check the range within which the values of the variable factors are permitted during the operation of the target system 911.

Furthermore, the input/output portion 901 accepts a user operation that instructs a change to the range within which the value of a variable factor is permitted to be during operation of the target system 911.

A user can relatively easily use the input/output portion 901 to adjust the range of possible values of the variable factor.

In addition, the input/output portion 901 displays points indicating the values of the variable factors for each coordinate axis in a coordinate space having, for each of a plurality of variable factors, coordinate axes indicating the values of the variable factors that are correlated with the operating status of the target system 911, which is a value that changes during operation of the target system 911, which is the system to be operated.

According to the system operation planning device 1, a user can visually ascertain the values of a plurality of variable factors, and in this respect, the values of a plurality of variable factors can be ascertained relatively easily. For example, the user can relatively easily ascertain the values of a plurality of variable factors that are set as the criteria for determining whether or not the system configuration of the target system 911 needs to be changed.

Furthermore, the input/output portion 901 displays in the coordinate space the range within which the values of the variable factors are permitted to be during operation of the target system 911.

According to the system operation planning device 1, a user can visually ascertain the range of values that multiple variable factors are allowable to take in a case where the target system 911 is operated, and in this respect, the range of values of the variable factors can be ascertained relatively easily.

Furthermore, the input/output portion 901 accepts a user operation for editing the points indicating the values of the variable factors for each coordinate axis in the above-mentioned coordinate space.

According to the system operation planning device 1, a user can designate the value of a variable factor by a relatively simple operation of editing a point that is displayed in a coordinate space and indicates the value of the variable factor. For example, the user can designate the value of a variable factor that is used as a criterion for determining whether or not the system configuration of the target system 911 needs to be changed.

### Second Example Embodiment

In the second example embodiment, a case will be described in which the system operation planning device further operates the system after planning the system operation.

The configuration of the system operation planning device according to the second example embodiment will be described.

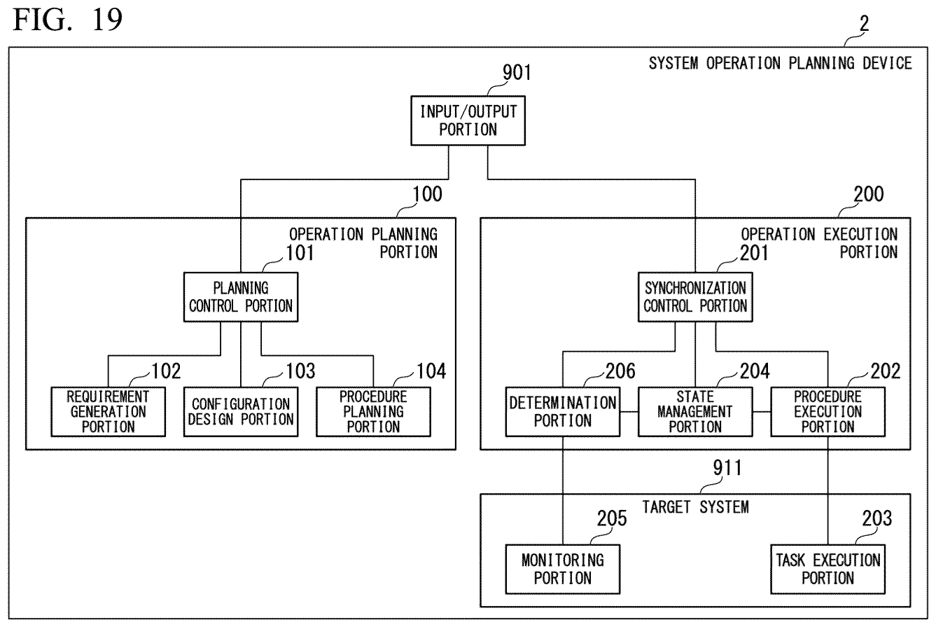

FIG. 19 is a block diagram illustrating an example of the functional configuration of the system operation planning device according to the second example embodiment. In the configuration shown in FIG. 19, the system operation planning device 2 includes an input/output portion 901, an operation planning portion 100, an operation execution portion 200, and a target system 911. The operation planning portion 100 is provided with a planning control portion 101, a requirement generation portion 102, a configuration design portion 103, and a procedure planning portion 104. The operation execution portion 200 includes a synchronization control portion 201, a procedure execution portion 202, a state management portion 204, and a determination portion 206. The target system 911 includes a monitoring portion 205 and a task execution portion 203.

Of the components shown in FIG. 19, those having similar functions to those shown in FIG. 1 are given the same reference numerals (100, 101, 102, 103, 104, 901) and will not be described in detail here.

The system operation planning device 2 is provided with the operation execution portion 200 and the target system 911 in addition to the constitutions shown in FIG. 1. As a result, the system operation planning device 2 operates the target system 911 based on the operation plan generated by the operation planning portion 100. In other respects, the system operation planning device is similar to the system operation planning device 1.

The target system 911 may be configured externally to the system operation planning device 2. As in the case of the system operation planning device 1, the input/output portion 901 may be configured externally to the system operation planning device 2.

The synchronization control portion 201 controls the target system 911 defined in the operation plan so that the target system 911 is always in the system configuration that it should be in accordance with the variable factors. The state management portion 204 records the operation plan and the current state of the target system 911. Based on the instruction from the synchronization control portion 201, the procedure execution portion 202 issues an instruction to the task execution portion 203, thereby executing the configuration change procedure. The procedure execution portion 202 corresponds to an example of a procedure execution means.

Making the system configuration of the target system 911 into the system configuration that it should be according to the variable factors is also referred to as synchronization of the target system 911.

The task execution portion 203 executes a task based on instructions from the procedure execution portion 202. The monitoring portion 205 monitors the values of the variable factors. The determination portion 206 determines a desired factor level, which is the level of the target variable factor value, based on the value of the variable factor obtained from the monitoring portion 205, and records the desired factor level in the state management portion 204. Furthermore, if the current factor level and the desired factor level are different, the determination portion 206 notifies the synchronization control portion 201 to that effect. The determination portion 206 corresponds to an example of a determination means.

Here, the factor level is the value (set of values) of the variable factor indicated in the management information. The factor levels are represented by discrete values, such as the example shown in part C of FIG. 2.

The current factor level is the factor level associated with the current system configuration of the target system 911.

The desired factor level is a factor level that is associated with a system configuration that can correspond to the current value of the variable factor observed for the target system 911.

As the desired factor level, for each variable factor, the factor level at which the value of each variable factor is smallest may be selected from among the factor levels that have a value greater than the current value of the variable factor. Alternatively, for a variable factor whose value exceeding the value indicated in the current factor level would be fatal to the target system 911, the factor level having the second smallest value of the variable factor among the factor levels having a value greater than the current value of the variable factor may be selected.

It should be noted that, here, the larger the value of the variable factor, the higher the performance of the target system 911. For variable factors for which the smaller the value of the variable factor, the higher the performance of the target system 911, in the explanation of the selection of the factor level, “large” should be read as “small”.

The state management portion 204 records the ID of the target system 911 as system state information related to the target system 911, along with the operation state, operation plan, current factor level, and desired factor level. The operation state is a flag indicating whether the operation is in progress or stopped. The operation execution portion 200 executes the monitoring and synchronization processes only in a case where the operation state of the target system 911 is in operation.

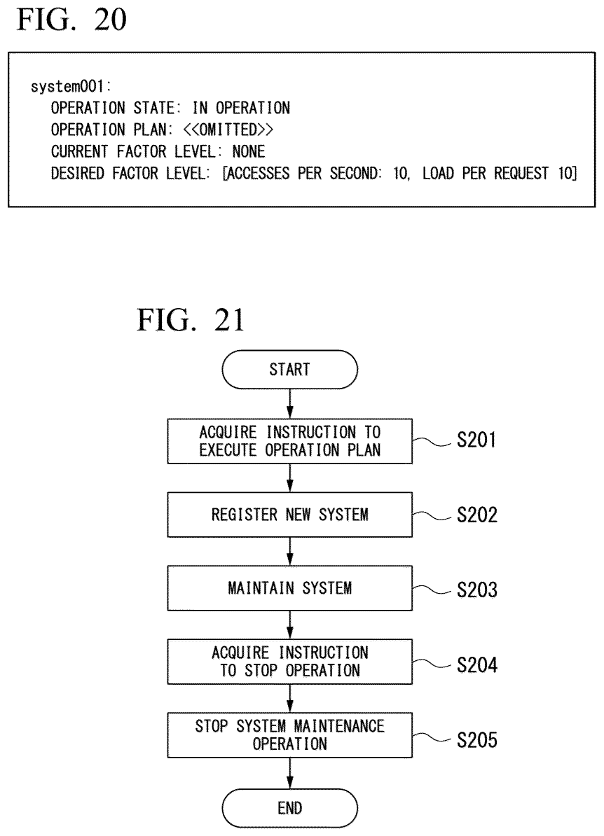

FIG. 20 is a diagram showing an example of system state information recorded in the state management portion 204. The system state information shown in FIG. 20 is information relating to a system having an ID of “system001”. The system state information shown in FIG. 20 records the operation state, operation plan, current factor level, and desired factor level. The operation state is “in operation”. The contents of the operation plan are similar to those of the operation plan shown in FIG. 14, for example, and will not be described here. The current factor level is “none”, indicating that the target system 911 is in an initial state. The desired factor level is “{accesses per second: 10, Load per request: 10}”.

Since the current factor level and the desired factor level are different, the procedure execution portion 202 needs to execute a configuration change procedure. In this case, the configuration change procedure is a task procedure for constructing a basic configuration, which is a system configuration that serves as the basis for the target system 911, from a state in which the system configuration of the target system 911 is nothing.

Next, the operation of the system operation planning device 2 will be described.

In the system operation planning device 2, similarly to the case of the system operation planning device 1, a user inputs abstract requirements via the input/output portion 901, and the operation planning portion 100 derives an operation plan based on the abstract requirements. The user checks the derived operation plan via the input/output portion 901, and instructs the system operation planning device 2 to execute the operation plan. In a case where the operation of the target system 911 is no longer necessary, the user instructs the system operation planning device 2 to stop the operation. The operation execution portion 200 receives information on the operation plan and instructions from the user, operates the target system 911, and stops the operation.

FIG. 21 is a flowchart showing an example of the procedures of the process performed by the operation execution portion 200.

In the process shown in FIG. 21, the synchronization control portion 201 acquires an instruction to execute the operation plan given by the user via the input/output portion 901 (Step S201). Then, the synchronization control portion 201 accepts the operation plan, generates a new system ID, and registers system state information consisting of the generated system ID and the operation plan in the state management portion 204 (Step S202).

In addition, the current factor level of the system state information at the time of registration can be “none”. Additionally, the desired factor level can be a base factor level such that all variable factor values have a base value specified in the variable factor definition. The operation state is “in operation”.

Next, the synchronization control portion 201 starts an operation for maintaining the state of the target system 911 in an appropriate state by executing the operation plan (Step S203).

Thereafter, in a case where a reason arises to stop the operation of the target system 911, the user instructs the operation execution portion 200 to stop the operation of the target system 911 via the input/output portion 901 (Step S204). As a result, the synchronization control portion 201 sets the operation state of the target system 911 to “stopped” and stops the operation of maintaining the target system 911 (Step S205).

After Step S205, the operation execution portion 200 ends the process of FIG. 21.

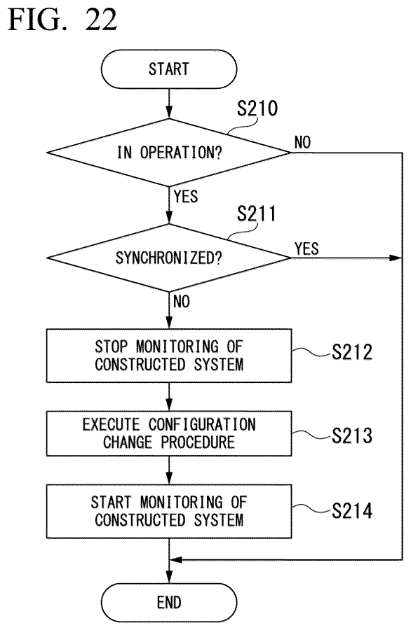

FIG. 22 is a flowchart showing an example of a processing procedure in an operation performed by the operation execution portion 200 to maintain the target system 911 in an appropriate state. The operation execution portion 200, for example, periodically repeats the process shown in FIG. 22.

In the process shown in FIG. 22, the synchronization control portion 201 determines whether the operation state of the target system 911 is “in operation” (Step S201). If it is determined that the system is not in operation (Step S201: NO), the operation execution portion 200 ends the process of FIG. 22.

On the other hand, in a case where it is determined that the operation state of the target system 911 is in operation (Step S201: YES), the synchronization control portion 201 determines whether the target system 911 is synchronized (Step S211). Specifically, the synchronization control portion 201 checks the system state information and determines whether the current factor level is the same as the desired factor level.

In a case where it is determined that the target system 911 is synchronized (Step S211: YES), the operation execution portion 200 ends the processing of FIG. 22.

On the other hand, in a case where it is determined that the target system 911 is not synchronized (Step S211: NO), the synchronization control portion 201 temporarily stops monitoring of the target system 911 by the monitoring portion 205 (Step S212). Then, the synchronization control portion 201 obtains a configuration change procedure for changing the system configuration from the system configuration that corresponds to the current factor level to the system configuration that corresponds to the desired factor level from the operation plan recorded in the state management portion 204, and sends the obtained configuration change procedure to the procedure execution portion 202 for execution (Step S213).

The procedure execution portion 202 executes the configuration change procedure by instructing the task execution portion 203 to execute each task indicated in the configuration change procedure, thereby synchronizing the system configuration of the target system 911 with the desired system configuration. After the target system 911 has been synchronized, the synchronization control portion 201 updates the record of the current factor level in the system state information recorded in the state management portion 204 to the desired factor level value.

Then, the synchronization control portion 201 causes the monitoring portion 205, via the determination portion 206, to start monitoring the target system 911 after the system configuration change (Step S214).

After Step S214, the operation execution portion 200 ends the process of FIG. 22.

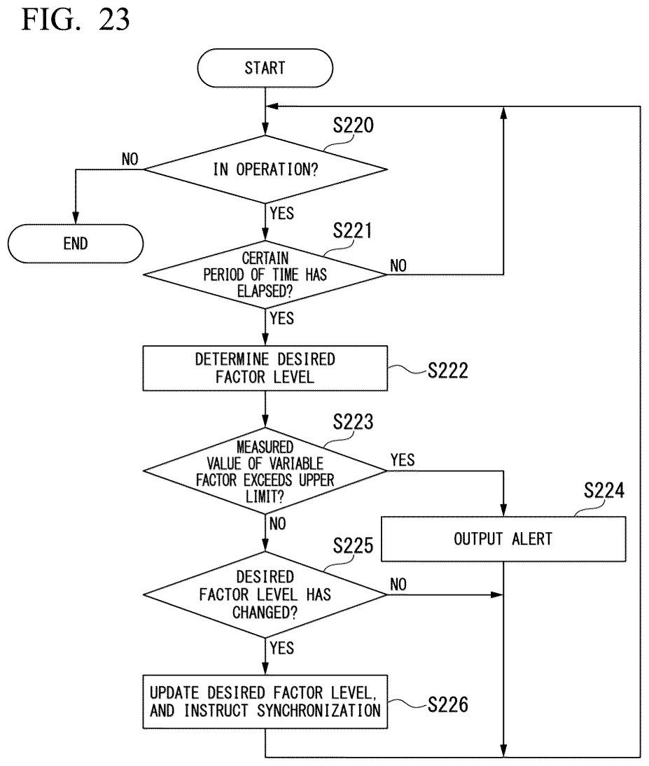

FIG. 23 is a flowchart showing an example of the processing procedure performed by the determination portion 206.

In the process shown in FIG. 23, the determination portion 206 determines whether the operation state of the target system is in operation (Step S220). In a case where it is determined that the target system is not in operation (Step S220: NO), the determination portion 206 ends the process of FIG. 23.

On the other hand, in a case where it is determined that the target system is in operation (Step S220: NO), the determination portion 206 determines whether a certain period of time defined as a cycle for determining synchronization has elapsed (Step S221). If the determination portion 206 determines that the certain period of time has not elapsed (Step S221: NO), the process returns to Step S220.

On the other hand, if it is determined that a certain period of time has elapsed (Step S221: YES), the determination portion 206 acquires the values of the variable factor observed by the monitoring portion 205, and determines and acquires the desired factor level from among the factor levels indicated in the operational information (Step S222).

Here, in order to operate the target system 911 stably it is necessary that the system configuration of the target system 911 be a system configuration with sufficient performance. On the other hand, if the target system 911 has surplus resources, this leads to a decrease in the efficiency of the target system 911, such as an increase in the power consumption of the target system 911.

Therefore, in a case where the monitoring portion 205 determines the desired factor level, as described above, it is possible to determine the factor level having the smallest value among the factor levels greater than the value of the observed variable factor.

On the other hand, in a case where the observed factor levels cross the boundaries of intervals, it is not advisable for the operation execution portion 200 to repeat frequent configuration changes. Therefore, the monitoring portion 205 may determine the desired factor level only in a case where the observed value of the variable factor remains at a particular factor level for a certain period of time, i.e., in a case where no variation in the desired factor level occurs for a certain period of time.

On the other hand, in a case where a significant fluctuation occurs in the factor level, the monitoring portion 205 may determine the desired factor level without waiting for a certain period of time to elapse. In addition, instead of using the observed value of the variable factor itself, the monitoring portion 205 may predict the future value of the variable factor based on the results of continuous monitoring of the value of the variable factor, and use the prediction result to determine the desired factor level.

After Step S222, the determination portion 206 determines whether or not the measured value of the variable factor exceeds the upper limit of the factor level that can be selected as the desired factor level (Step S223). For example, the determination portion 206 determines whether or not there is any variable factor whose measured value is greater than a value set as the maximum value of the variable factor.

If the measured value of a variable factor exceeds the upper limit of the factor level that can be selected as the desired factor level, it means that an appropriate system configuration cannot be selected as the system configuration of the target system 911 according to the value of the variable factor.

If it is determined that the measured value of the variable factor exceeds the upper limit of the factor level that can be selected as the desired factor level (Step S223: YES), the determination portion 206 issues an alert to the user via the synchronization control portion 201 and the input/output portion 901 (Step S224).

After Step S224, the process returns to Step S220.

On the other hand, if it is determined in Step S223 that the measured value of the variable factor does not exceed the upper limit of the factor level that can be selected as the desired factor level (Step S223: NO), the determination portion 206 determines whether the desired factor level has changed from the current factor level (Step S225).

If the determination portion 206 determines that the desired factor level has not changed from the current factor level (Step S225: NO), the process returns to Step S220.

On the other hand, if it is determined that the desired factor level has changed from the current factor level (Step S225: NO), the determination portion 206 updates the desired factor level recorded by the state management portion 204 to the desired factor level value determined in Step S222, and instructs the synchronization control portion 201 to synchronize the target system 911 (Step S225).

After Step S225, the process returns to Step S220.

Next, the effects of the second example embodiment will be described.

According to the system operation planning device 2, the process of formulating a series of operation plans including configuration changes according to values of variable factors, and the process of operating the target system 911 based on the operation plans are automated. In addition, according to the system operation planning device 2, a series of configuration information and configuration change procedures are planned before operation of the target system 911 begins, so that it is expected that configuration changes can be implemented quickly and reliably in a case where a response is required.

As described above, the procedure execution portion 202 changes the system configuration of the target system 911 based on a configuration change procedure that indicates the procedure for changing the system configuration of the target system 911 to a system configuration that satisfies specific requirements that correspond to the value of a variable factor obtained using a configuration for performing observations to obtain the value of a variable factor.

According to the system operation planning device 2, the system configuration of the target system 911 can be performed automatically.

In addition, the determination portion 206 compares the value of the variable factor indicated by the specific requirements satisfied by the current system configuration of the target system 911 with the value of the variable factor indicated by the specific requirements corresponding to the value of the variable factor obtained using a configuration for performing observations to obtain the value of the variable factor, and judges whether or not the system configuration of the target system 911 needs to be changed.

According to the system operation planning device 2, it is possible to automatically determine whether or not the system configuration of the target system 911 needs to be changed.

### Third Example Embodiment

In the third example embodiment, a case will be described in which a system operation planning device does not generate a prior operation plan, but determines the need for a system configuration change based on the results of system monitoring, and plans and executes a system configuration change as necessary. In the third example embodiment, the system operation planning device performs system operation planning and operation on a so-called “on the fly” basis.

The configuration of the system operation planning device according to the third example embodiment will be described.

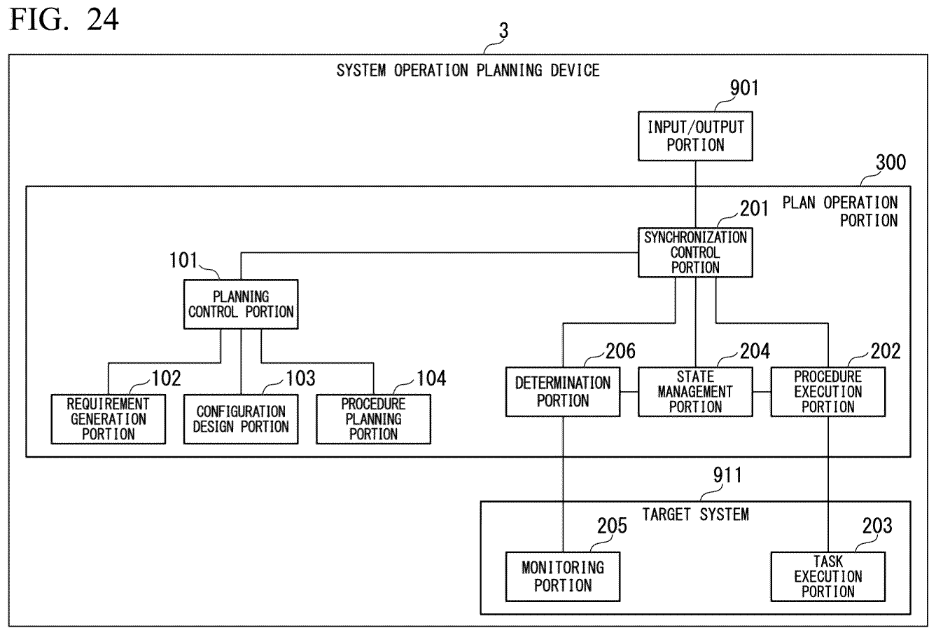

FIG. 24 is a block diagram illustrating an example of the functional configuration of the system operation planning device according to the third example embodiment. In the configuration shown in FIG. 24, the system operation planning device 3 is provided with an input/output portion 901, a plan operation portion 300, and a target system 911. The plan operation portion 300 is provided with a planning control portion 101, a requirement generation portion 102, a configuration design portion 103, a procedure planning portion 104, a synchronization control portion 201, a procedure execution portion 202, a state management portion 204, and the determination portion 206. The target system 911 is provided with a monitoring portion 205 and a task execution portion 203.

Of the components shown in FIG. 24, those having similar functions to those shown in FIG. 10 are given the same reference numerals (101, 102, 103, 104, 201, 202, 203, 204, 205, 206, 901, 911) and will not be described in detail here.

In the system operation planning device 3, the plan operation portion 300 has both portions corresponding to each portion of the operation planning portion 100 in FIG. 19, as well as portions that correspond to each portion of the operation execution portion 200. Thereby, the system operation planning device 3 performs system operation planning and operation on the fly, so to speak, as described above. In other respects, the system operation planning device 3 is similar to the system operation planning device 2.

Next, data handled by the system operation planning device 3 and the operation of the system operation planning device 3 will be described.

In the system operation planning device 3, the state management portion 204 records the ID of the target system 911 as system state information regarding the target system 911, along with the operation state of the target system 911, abstract requirement, current factor level, desired factor level, and current system configuration.

In the system operation planning device 3, in a case where the deviation between the observed value of the variable factor and the current factor level is greater than a predetermined threshold, the determination portion 206 determines a desired factor level based on the observed value of the variable factor and updates the desired factor level recorded by the state management portion 204. Then, the determination portion 206 notifies the synchronization control portion 201 to the effect that the desired factor level has changed.

In the system operation planning device 3, the synchronization control portion 201, upon receiving a notification from the determination portion 206, notifies the planning control portion 101 of the abstract requirement, the desired factor level, and the current system configuration. Then, the synchronization control portion 201 acquires the desired system configuration and the configuration change procedure from the planning control portion 101. The synchronization control portion 201 sends the acquired configuration change procedure to the procedure execution portion 202 to execute the configuration change. After the system configuration of the target system 911 is changed, the synchronization control portion 201 updates the current factor level record in the system state information recorded in the state management portion 204 to the desired factor level value.

In the system operation planning device 3, the planning control portion 101, upon acquiring the abstract requirement, desired factor level, and current system configuration from the synchronization control portion 201, sends the abstract requirement and the desired factor level to the requirement generation portion 102. Then, the planning control portion 101 acquires the specific requirement from the requirement generation portion 102, and sends the acquired specific requirement to the configuration design portion 103. Then, the planning control portion 101 acquires a desired system configuration from the configuration design portion 103, and sends the current system configuration and the acquired desired system configuration to the procedure planning portion 104. The planning control portion 101 acquires the configuration change procedure from the procedure planning portion 104, and outputs the desired system configuration and the configuration change procedure to the synchronization control portion 201.

In the system operation planning device 3, the requirement generation portion 102, upon acquiring the abstract requirement and the desired factor level from the planning control portion 101, writes the acquired desired factor level value as the value of the variable factor in the abstract requirement. Then, the requirement generation portion 102 generates specific requirements by generating monitoring requirements for the variable factors, and outputs the specific requirements to the planning control portion 101.

In the system operation planning device 3, the configuration design portion 103, upon acquiring specific requirements from the planning control portion 101, generates configuration information based on the specific requirements and outputs the generated configuration information to the planning control portion 101.

In the system operation planning device 3, the procedure planning portion 104, upon acquiring the current system configuration and the desired system configuration from the planning control portion 101, generates a configuration change procedure for changing the system configuration of the target system 911 from the current system configuration to the desired system configuration. Then, the procedure planning portion 104 outputs the generated configuration change procedure to the planning control portion 101.

Next, the effects of the third example embodiment will be described.

According to the third example embodiment, a series of operational tasks including configuration changes according to values of variable factors are automated.

As described above, in a case where the deviation between the value of a variable factor indicated by a specific requirement satisfied by the current system configuration of the target system 911 and the value of the variable factor obtained using a configuration for performing observations to obtain the value of the variable factor is greater than a predetermined threshold, the determination portion 206 determines whether or not it is necessary to change the system configuration of the target system 911 by finding the value of the variable factor indicated by the specific requirement that corresponds to the value of the variable factor obtained using a configuration for performing observations to obtain the value of the variable factor.

According to the system operation planning device 3, it is possible to automatically determine whether or not the system configuration of the target system 911 needs to be changed.

### Fourth Example Embodiment

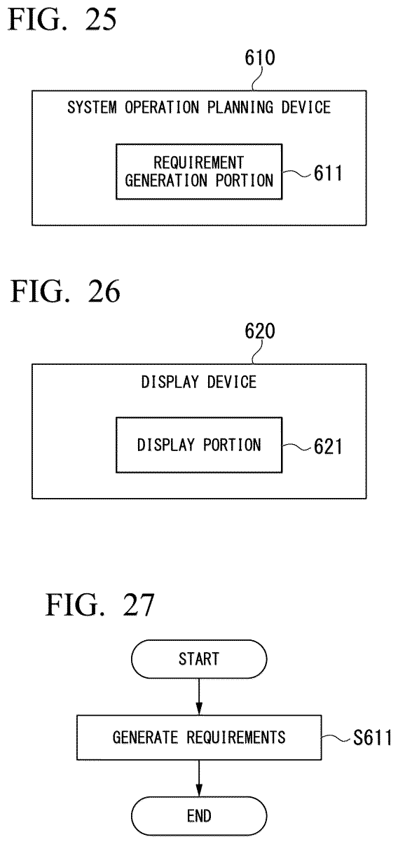

FIG. 25 is a diagram showing an example of the configuration of the system operation planning device according to the fourth example embodiment. In the configuration shown in FIG. 25, a system operation planning device 610 is provided with a requirement generation portion 611.

In such a configuration, on the basis of abstract requirements that are information indicating requirements to be satisfied by a target system as a system to be operated, the information including information indicating a variable factor range as a range of values allowed for a variable factor to take during operation of the target system, the value of the variable factor being a value varying during the operation of the target system and having a correlation with an operation status of the target system, the requirement generation portion 611 generates specific requirements which are information indicating requirements to be satisfied by the target system, the information including information indicating values of each of a plurality of values of the variable factor included in the variable factor range.

According to the system operation planning device 610, the values of the variable factors indicated by each of multiple specific requirements can be used as a judgment criterion for automatically determining whether or not to change the system configuration of the target system during operation of the target system. By designing a system configuration that satisfies a specific requirement, it is possible to obtain a system configuration that is suitable in a case where the value of a variable factor is the value of the variable factor indicated by that specific requirement.

In particular, in the system operation planning device 610, the variable factors are not limited to those in a specific field. According to the system operation planning device 610, it is possible to obtain decision criteria for automatically determining whether or not to change the system configuration of the target system for various fields of target systems.

### Fifth Example Embodiment

FIG. 26 is a diagram illustrating an example of the configuration of the display device according to the fifth example embodiment. In the configuration shown in FIG. 26, the display device 620 is provided with a display portion 621.

With this configuration, the display portion 621 also displays a list of variable factors whose values change during operation of the target system, which is the system to be operated, and whose values have a correlation with the operating status of the target system.

The display portion 621 corresponds to an example of a display means.

According to the display device 620, a user can refer to the list of variable factors and select, from among the variable factors, a variable factor to be used as a criterion for determining whether or not to change the system configuration of the target system.

### Sixth Example Embodiment

The configuration of the display device according to the sixth example embodiment is similar to the configuration of the display device according to the fifth example embodiment. In describing the sixth example embodiment, reference will be made to FIG. 26.

FIG. 26 is a diagram illustrating an example of the configuration of the display device according to the sixth example embodiment. In the configuration shown in FIG. 26, the display device 620 is provided with a display portion 621.

In this configuration, the display portion 621 displays a range of values allowed for a variable factor to take during operation of the target system as the system to be operated, the value of the variable factor being a value varying during the operation of the target system and having a correlation with an operation status of the target system.

The display portion 621 corresponds to an example of a display means.

By using the display device 620, a user can refer to the display by the target system and confirm the range within which the values of the variable factors are permitted to be during operation of the target system.

### Seventh Example Embodiment

The configuration of the display device according to the seventh example embodiment is similar to the configuration of the display device according to the fifth example embodiment. In describing the seventh example embodiment, reference will be made to FIG. 26.

FIG. 26 is a diagram illustrating an example of the configuration of the display device according to the seventh example embodiment. In the configuration shown in FIG. 26, the display device 620 is provided with a display portion 621.

In this configuration, the display portion 621 displays points indicating the values of the variable factors for each coordinate axis in a coordinate space having, for each of a plurality of variable factors, coordinate axes indicating the values of the variable factors that are correlated with the operating status of the target system, which is a value that changes during operation of the target system 911, which is the system to be operated.

According to the display device 620, a user can visually ascertain the values of a plurality of variable factors, and in this respect, the values of a plurality of variable factors can be ascertained relatively easily. For example, the user can relatively easily ascertain the values of a plurality of variable factors that are set as the criteria for determining whether or not the system configuration of the target system needs to be changed.

### Eighth Example Embodiment

FIG. 27 is a diagram showing an example of processing procedures in the system operation planning method in the eighth example embodiment. The system operation planning method shown in FIG. 27 includes generating requirements (Step S611).

In generating requirements (Step S611), on the basis of abstract requirements that are information indicating requirements to be satisfied by a target system as a system to be operated, the information including information indicating a variable factor range as a range of values allowed for a variable factor to take during operation of the target system, the value of the variable factor being a value varying during the operation of the target system and having a correlation with an operation status of the target system, a computer generates specific requirements as information indicating requirements to be satisfied by the target system, the information including information indicating values of each of a plurality of values of the variable factor included in the variable factor range.

According to the system operation planning method shown in FIG. 27, the values of the variable factors indicated by each of multiple specific requirements can be used as a judgment criterion for automatically determining whether or not to change the system configuration of the target system during operation of the target system. By designing a system configuration that satisfies a specific requirement, it is possible to obtain a system configuration that is suitable in a case where the value of a variable factor is the value of the variable factor indicated by that specific requirement.

In particular, according to the system operation planning method shown in FIG. 27, the variable factors are not limited to those in a specific field. According to the system operation planning method shown in FIG. 27, it is possible to obtain a criterion for automatically determining whether or not to change the system configuration of the target system in various fields.

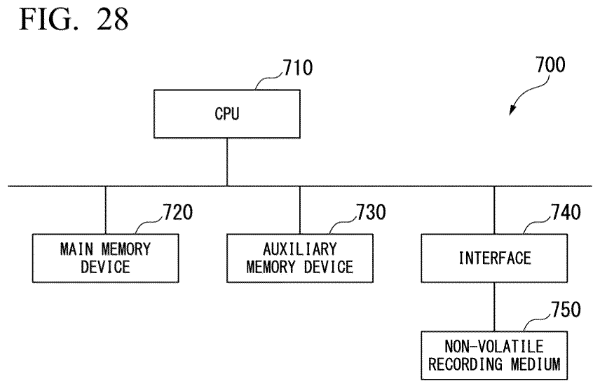

FIG. 28 is a schematic block diagram illustrating the configuration of a computer according to at least one example embodiment.

In the configuration shown in FIG. 28, a computer 700 is provided with a CPU 710, a main memory device 720, an auxiliary memory device 730, an interface 740, and a non-volatile recording medium 750.

Any one or more of the above-mentioned system operation planning device 1, system operation planning device 2, system operation planning device 3, system operation planning device 610, and display device 620, or a part thereof, may be implemented in the computer 700. In this case, the operations of the above-mentioned processing portions are stored in the auxiliary memory device 730 in the form of a program. The CPU 710 reads the program from the auxiliary memory device 730, loads it into the main memory device 720, and executes the above-mentioned processing in accordance with the program. Furthermore, the CPU 710 allocates storage areas in the main memory device 720 corresponding to the above-mentioned respective storage portions in accordance with the program. Communication between each device and other devices is performed by the interface 740 having a communication function and performing communication under the control of the CPU 710.

In a case where the system operation planning device 1 is implemented in the computer 700, the operations of the input/output portion 901, the operation planning portion 100, and each of the portions thereof are stored in the auxiliary memory device 730 in the form of a program. The CPU 710 reads the program from the auxiliary memory device 730, loads it into the main memory device 720, and executes the above-mentioned processing in accordance with the program.

Furthermore, the CPU 710 reserves storage areas in the main memory device 720 for the system operation planning device 1 to perform processing according to the program. The communication between the system operation planning device 1 and other devices is performed by the interface 740 having a communication function and operating under the control of the CPU 710. Interaction between the system operation planning device 1 and the user is performed by the interface 740, which is provided with a display device and an input device, displaying various images under the control of the CPU 710, and accepting user operations.

In a case where the system operation planning device 2 is implemented in the computer 700, the operations of the input/output portion 901, the operation planning portion 100, the operation execution portion 200, the target system 911, and each of the portions thereof are stored in the auxiliary memory device 730 in the form of a program. The CPU 710 reads the program from the auxiliary memory device 730, loads it into the main memory device 720, and executes the above-mentioned processing in accordance with the program.

Furthermore, the CPU 710 reserves storage areas in the main memory device 720 for the system operation planning device 2 to perform processing according to the program. The communication between the system operation planning device 2 and other devices is performed by the interface 740 having a communication function and operating under the control of the CPU 710. Interaction between the system operation planning device 2 and the user is performed by the interface 740, which is provided with a display device and an input device, displaying various images under the control of the CPU 710, and accepting user operations.

In a case where the system operation planning device 3 is implemented in the computer 700, the operations of the input/output portion 901, the plan operation portion 300, the target system 911, and the portions thereof are stored in the auxiliary memory device 730 in the form of a program. The CPU 710 reads the program from the auxiliary memory device 730, loads it into the main memory device 720, and executes the above-mentioned processing in accordance with the program.

Furthermore, the CPU 710 reserves a storage area in the main storage device 720 for the system operation planning device 3 to perform processing according to the program. The communication between the system operation planning device 3 and other devices is performed by the interface 740 having a communication function and operating under the control of the CPU 710. Interaction between the system operation planning device 3 and the user is performed by the interface 740, which is provided with a display device and an input device, displaying various images under the control of the CPU 710, and accepting user operations.

In a case where the system operation planning device 610 is implemented in the computer 700, the operation of the requirement generation portion 611 is stored in the auxiliary memory device 730 in the form of a program. The CPU 710 reads the program from the auxiliary memory device 730, loads it into the main memory device 720, and executes the above-mentioned processing in accordance with the program.

Furthermore, the CPU 710 reserves a storage area in the main storage device 720 for the system operation planning device 610 to perform processing according to the program. The communication between the system operation planning device 610 and other devices is performed by the interface 740 having a communication function and operating under the control of the CPU 710. Interaction between the system operation planning device 610 and the user is performed by the interface 740, which is provided with a display device and an input device, displaying various images under the control of the CPU 710, and accepting user operations.

In a case where the display device 620 is implemented in the computer 700, the operation of the display portion 621 is stored in the auxiliary memory device 730 in the form of a program. The CPU 710 reads the program from the auxiliary memory device 730, loads it into the main memory device 720, and executes the above-mentioned processing in accordance with the program.

Furthermore, the CPU 710 reserves a storage area in the main memory device 720 for the display device 620 to perform processing in accordance with the program. Communication between the display device 620 and other devices is performed by the interface 740 having a communication function and operating under the control of the CPU 710. Interaction between the display device 620 and the user is performed by the interface 740, which is provided with a display device and an input device, displaying various images under the control of the CPU 710, and accepting user operations.

Any one or more of the above-mentioned programs may be recorded in the non-volatile recording medium 750. In this case, the interface 740 may read the program from the non-volatile recording medium 750. The CPU 710 may then directly execute the program read by the interface 740, or may temporarily store the program in the main memory device 720 or the auxiliary memory device 730 and then execute it.

In addition, a program for executing all or part of the processing performed by system operation planning device 1, system operation planning device 2, system operation planning device 3, system operation planning device 610, and display device 620 may be recorded on a computer-readable recording medium, and the program recorded on this recording medium may be read into a computer system and executed to perform processing of each part. It should be noted that the term “computer system” herein includes an OS (Operating System) and hardware such as peripheral devices.

In addition, the term “computer-readable recording medium” refers to portable media such as flexible disks, optical magnetic disks, ROMs (Read Only Memory), and CD-ROMs (Compact Disc Read Only Memory), as well as storage devices such as hard disks built into computer systems. Furthermore, the above program may be for realizing some of the functions described above, and may further be capable of realizing the functions described above in combination with a program already recorded in the computer system.

Although example embodiments of the present invention have been described in detail above with reference to the drawings, the specific configuration is not limited to these example embodiments, and designs that do not deviate from the gist of the present invention are also included.

A part or all of the above-described example embodiments can be described as, but is not limited to, the following supplementary notes.

### (Supplementary Note 1)

A system operation planning device generating,
based on abstract requirements that are information indicating requirements to be satisfied by a target system as a system to be operated, specific requirements that are information indicating requirements to be satisfied by the target system, the specific requirements including information indicating values of each of a plurality of values of a variable factor included in a variable factor range, the information including information indicating a variable factor range as a range of values allowed for a variable factor to take during operation of the target system, the value of the variable factor being a value varying during the operation of the target system and having a correlation with an operation status of the target system.

### (Supplementary Note 2)

The system operation planning device as described in Supplementary Note 1,
wherein in a case where generating the specific requirements, the specific requirements are generated including a requirement that the target system includes a configuration for performing an observation in order to obtain a value of the variable factor.

### (Supplementary Note 3)

The system operation planning device as described in Supplementary Note 1 or Supplementary Note 2, further comprising:
a configuration design means that generates configuration information indicating a system configuration of the target system that satisfies each of the specific requirements.

### (Supplementary Note 4)

The system operation planning device as described in Supplementary Note 3, further comprising:
a procedure planning means that generates a configuration change procedure which is information indicating a procedure for changing a system configuration indicated by one of the configuration information to a system configuration indicated by another of the configuration information.

### (Supplementary Note 5)

The system operation planning device as described in Supplementary Note 4, further comprising:
a planning control portion that generates an operation plan that is information including information linking each of the specific requirements with the configuration change procedure that indicates a procedure for changing the system configuration of the target system to a system configuration that satisfies the requirements.

### (Supplementary Note 6)

The system operation planning device as described in Supplementary Note 4 or Supplementary Note 5, further comprising:
a procedure execution means that changes the system configuration of the target system based on the configuration change procedure indicating a procedure for changing the system configuration of the target system to a system configuration that satisfies the specific requirement corresponding to the value of the variable factor obtained using a configuration for performing observation to obtain the value of the variable factor.

### (Supplementary Note 7)

The system operation planning device as described in any one of supplementary notes 1 to 6, further comprising:
a determination means that compares the value of the variable factor indicated by the specific requirements satisfied by the current system configuration of the target system with the value of the variable factor indicated by the specific requirements corresponding to the value of the variable factor obtained using a configuration for performing observations to obtain the value of the variable factor, and determines whether or not the system configuration of the target system needs to be changed.

### (Supplementary Note 8)

The system operation planning device as described in Supplementary Note 7,
wherein the determination means, in a case where a deviation between the value of the variable factor indicated by the specific requirement satisfied by the current system configuration of the target system and the value of the variable factor obtained using a configuration for performing observation to obtain the value of the variable factor is greater than a predetermined threshold, determines the value of the variable factor indicated by the specific requirement corresponding to the value of the variable factor obtained using a configuration for performing observation to obtain the value of the variable factor, and determines whether or not a change to the system configuration of the target system is necessary.

### (Supplementary Note 9)

A display device comprising:
a display means that displays a list of variable factors whose values change during operation of a target system, which is a system to be operated, and whose values have a correlation with the operating status of the target system.

### (Supplementary Note 10)

The display device as described in Supplementary Note 9, further comprising:
an operation input means that receives a user operation for designating a variable factor to be used for determining whether or not a change in the system configuration of the target system is required during operation of the target system, among the variable factors shown in the list.

### (Supplementary Note 11)

A display device comprising:
a display means that displays a range of values allowed for a variable factor to take during operation of a target system as a system to be operated, the value of the variable factor being a value varying during the operation of the target system and having a correlation with an operation status of the target system.

### (Supplementary Note 12)

The display device as described in Supplementary Note 11, further comprising:
an operation input means that receives a user operation for instructing a change in a range within which the value of the variable factor is allowed to be during operation of the target system.

### (Supplementary Note 13)

A display device comprising:
a display means that displays, in a coordinate space having for each of a plurality of variable factors a coordinate axis, points indicating the values of the variable factor of each coordinate axis indicating values of the variable factor, which varies during the operation of a target system as a system to be operated and has a correlation with an operation status of the target system.

### (Supplementary Note 14)

The display device as described in Supplementary Note 13,
wherein the display means displays in the coordinate space a range in which the value of the variable factor is allowed to be during operation of the target system.

### (Supplementary Note 15)

The display device as described in Supplementary Note 13 or Supplementary Note 14, further comprising:
an operation input means that receives a user operation for editing a point indicating a value of the variable factor for each of the coordinate axes in the coordinate space.

### (Supplementary Note 16)

A system operation planning method executed by a computer, the method comprising:
based on abstract requirements that are information indicating requirements to be satisfied by a target system as a system to be operated, generating specific requirements that are information indicating requirements to be satisfied by the target system, the specific requirements including information indicating values of each of a plurality of values of a variable factor included in a variable factor range, the information including information indicating a variable factor range as a range of values allowed for a variable factor to take during operation of the target system, the value of the variable factor being a value varying during the operation of the target system and having a correlation with an operation status of the target system.

### (Supplementary Note 17)

A recording medium containing a program for causing a computer to:
based on abstract requirements that are information indicating requirements to be satisfied by a target system as a system to be operated, generate specific requirements that are information indicating requirements to be satisfied by the target system, the specific requirements including information indicating values of each of a plurality of values of a variable factor included in a variable factor range, the information including information indicating a variable factor range as a range of values allowed for a variable factor to take during operation of the target system, the value of the variable factor being a value varying during the operation of the target system and having a correlation with an operation status of the target system.

### INDUSTRIAL APPLICABILITY

The present invention may be applied to a system operation planning device, a display device, a system operation planning method, and a recording medium.

### DESCRIPTION OF REFERENCE SIGNS

1, 2, 3, 610 System operation planning device
100 Operation planning portion
101 Planning control portion
102, 611 Requirement generation portion
103 Configuration design portion
104 Procedure planning portion
200 Operation execution portion
201 Synchronization control portion
202 Procedure execution portion
203 Task execution portion
204 State management portion
205 Monitoring portion
206 Determination portion
300 Plan operation portion
620 Display device
621 Display portion
901 Input/output portion
911 Target system

What is claimed is:

1. A system operation planning device comprising:
at least one memory configured to store instructions; and
at least one processor configured to execute the instructions to:
generate, based on abstract requirements that are information indicating requirements to be satisfied by a target system as a system to be operated, specific requirements that are information indicating requirements to be satisfied by the target system, the specific requirements including information indicating values of each of a plurality of values of a variable factor included in a variable factor range, the information including information indicating a variable factor range as a range of values allowed for a variable factor to take during operation of the target system, the value of the variable factor being a value varying during the operation of the target system and having a correlation with an operation status of the target system.

2. The system operation planning device according to claim 1, wherein in a case where generating the specific requirements, the specific requirements are generated including a requirement that the target system includes a configuration for performing an observation in order to obtain a value of the variable factor.

3. The system operation planning device according to claim 1, wherein the at least one processor is configured to execute the instructions to generate
configuration information indicating a system configuration of the target system that satisfies each of the specific requirements.

4. The system operation planning device according to claim 3, wherein the at least one processor is configured to execute the instructions to generate
a configuration change procedure which is information indicating a procedure for changing a system configuration indicated by one of the configuration information to a system configuration indicated by another of the configuration information.

5. The system operation planning device according to claim 4, wherein the at least one processor is configured to execute the instructions to generate
an operation plan that is information including information linking each of the specific requirements with the configuration change procedure that indicates a procedure for changing the system configuration of the target system to a system configuration that satisfies the requirements.

6. The system operation planning device according to claim 4, wherein the at least one processor is configured to execute the instructions to change
the system configuration of the target system based on the configuration change procedure indicating a procedure for changing the system configuration of the target system to a system configuration that satisfies the specific requirement corresponding to the value of the variable factor obtained using a configuration for performing observation to obtain the value of the variable factor.

7. The system operation planning device according to claim 1, wherein the at least one processor is configured to execute the instructions to:
compare the value of the variable factor indicated by the specific requirements satisfied by a current system configuration of the target system with the value of the variable factor indicated by the specific requirements corresponding to the value of the variable factor obtained using a configuration for performing observations to obtain the value of the variable factor; and
determine whether or not the system configuration of the target system needs to be changed.

8. The system operation planning device according to claim 7, wherein the at least one processor is configured to execute the instructions to, in a case where a deviation between the value of the variable factor indicated by the specific requirement satisfied by the current system configuration of the target system and the value of the variable factor obtained using a configuration for performing observation to obtain the value of the variable factor is greater than a predetermined threshold, determine the value of the variable factor indicated by the specific requirement corresponding to the value of the variable factor obtained using a configuration for performing observation to obtain the value of the variable factor, and determines whether or not the system configuration of the target system needs to be changed.

9. A display device comprising:
a display configured to display a list of variable factors whose values change during operation of a target system, which is a system to be operated, and whose values have a correlation with the operating status of the target system.

10. The display device according to claim 9, further comprising:
an interface configured to receive a user operation for designating a variable factor to be used for determining whether or not the system configuration of the target system needs to be changed during operation of the target system, among the variable factors shown in the list.

11. (canceled)

12. (canceled)

13. (canceled)

14. (canceled)

15. (canceled)

16. A system operation planning method executed by a computer, the method comprising:
based on abstract requirements that are information indicating requirements to be satisfied by a target system as a system to be operated, generating specific requirements that are information indicating requirements to be satisfied by the target system, the specific requirements including information indicating values of each of a plurality of values of a variable factor included in a variable factor range, the information including information indicating a variable factor range as a range of values allowed for a variable factor to take during operation of the target system, the value of the variable factor being a value varying during the operation of the target system and having a correlation with an operation status of the target system.

17. (canceled)
